(19) United States
(12) Patent Application Publication
(10) Pub. No.: US 2006/0020782 A1
(43) Pub. Date: Jan. 26, 2006

(54) Certificate transmission apparatus, communication system, certificate transmission method, and computer-executable program product and computer-readable recording medium thereof

(76) Inventor: Hiroshi Kakii, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/183,071

(22) Filed: Jul. 18, 2005

(30) Foreign Application Priority Data
Jul. 20, 2004 (JP) 2004-211626
Jun. 27, 2005 (JP) 2005-187219

(51) Int. Cl. H04L 9/00

(52) U.S. Cl. 713/156

(57) ABSTRACT

A certificate transmission apparatus includes a receiving part receiving a public key created by a sender device, an examination part examining the sender device of the public key, and a sending part sending a public key certificate including the public key received by the receiving part to the sender device of the public key.

### BACKGROUND OF THE INVENTION

1. Field of the Invention

The present invention generally relates to certificate transmission apparatuses, communication systems, certificate transmission methods, and computer-executable program products and computer-readable recording media thereof, and more particularly to a certificate transmission apparatus for transmitting a public key certificate to another device, a communication system including such the certificate transmission apparatus and a communication device as a communication partner to communicate the certificate transmission apparatus, a certificate transmission method for transmitting a public key certificate to another device, and a computer-executable program product for causing a computer to function as the certificate transmission apparatus, and computer-readable recording medium recorded with a program for causing a computer to transmit the public key certificate to another device.

2. Description of the Related Art

Conventionally, a plurality of communication devices each having a communication function are mutually connected through a network so as to architect various systems. As an example, a system so-called “electronic commerce system” has been architected so that a computer such as a PC (personal computer) or a like functioning as a client terminal sends an order of a product and a server computer connecting to the client terminal through the Internet accepts that order. In addition, a system is proposed in that a function of the client terminal or the server computer is implemented to various electronic apparatuses, and the electronic apparatuses are connected to each other through a network, to conduct a remote management of the electronic apparatuses by intercommunications.

In order to architect this system, it is important to check whether a communication partner is a proper partner or whether information sent from the communication partner is tampered with when communicating with the communication partner. In addition, particularly in the Internet, the information generally passes through irrelevant computers toward the communication partner. When confidential information is transmitted, it is necessary to protect contents of the confidential information. Then, as a communication protocol corresponding to this requirement, for example, a protocol called an SSL (Secure Socket Layer) has been developed, and widely used. In communication using this protocol, it is possible to prevent falsification and interception by encrypting the confidential information in addition to combining a public key encryption method and a shared key encryption method and authenticating the communication partner. Also, at a side of the communication partner, it is possible to authenticate a device as a communication originator requesting communication.

Japanese Laid-Open Patent Applications No. 2002-353959 and No. 2002-251492 disclose technologies related to an authentication using the SSL and the public key encryption.

In the following, a communication procedure in a case of conducting a mutual authentication in accordance with the SSL will be described while focusing on a portion of the authentication process. FIG. 1 is a diagram showing a flowchart conducted by each of communication devices A and B when the communication devices A and B conduct a mutual authentication in accordance with the SSL, accompanying with information used in each process.

As shown in FIG. 1, when the mutual authentication is conducted in accordance with the SSL, it is necessary for the communication devices A and B to store a combination of a root key certificate and a private key and a combination of the root key certificate and a public key certificate, respectively. The private key is a key which a CA (Certificate Authority) issues for each of the communication devices A and B. The public key certificate is a digital certificate in that the CA additionally provides a digital signature to the public key corresponding to the private key. Also, the root key certificate is a digital certificate in which the CA additionally provides the digital signature to a root key corresponding to a root private key used for the digital signature.

FIG. 2A and FIG. 2B show their relationships.

As shown in FIG. 2A, a public key A includes a key body for decrypting a document which is encrypted by using a private key A, and bibliography information including information concerning an issuer (CA) of the public key, a valid term, and a like. In order to show that the key body and the bibliography information are not tampered, the CA encrypts a hash value obtained by conducting a hash process with respect to the public key A, by using the root private key, and additionally provides the hash valued being encrypted as digital signature to the public key of a client. Also, in this case, identification information of the root private key used for the digital signature is additionally provided to the bibliography information of the public key A as signature key information. Accordingly, the public key certificate to which this digital signature is provided is a public key certificate A.

In a case of using the public key certificate A for the authentication process, the digital signature included in the public key certificate A is decoded by using the key body of the root key as the public key corresponding to the root public key. When this decryption is normally conducted, it is recognized that the digital signature is surely provided by the CA. Moreover, if a hash value obtained by conducting the hash process with respect to the portion of the public key A is identical to a hash value obtained from the decryption, it is recognized that the key itself is not suffering from compromised and tampered.

Also, if received data is normally decrypted by using the public key A, it is recognized that the received data is surely sent from an owner of the private key A.

In order to conduct the authentication process, it is necessary to store the root key beforehand. As shown in FIG. 2B, the root key is also stored as the root key certificate to which the CA provides the digital signature. In this case, the root key certificate is a self-signature format in which the digital signature can be decrypted with the public key included in the root key certificate itself. When the root key is used, the digital signature is decrypted by using the key body included in the root key certificate, and the root key is compared with the hash value obtained by the hash process. If the root key is identical to the hash value, it can be confirmed that the root key is not compromised.

Each of the flowcharts shown in FIG. 1 will be described. It should be noted that arrows between two flowcharts denote data transmission. A sender side conducts a transmission process in a step at a start point of the arrow, and a receiver side conducts a process in a step at an end point of the arrow when the receiver side receives data from the sender side. Moreover, if a process in each step is not normally ended, a response showing an authentication failure is returned to the communication partner and the process is terminated in that step. When the authentication failure is received from the communication partner, or when the process is timed out, similarly, the response showing an authentication failure is returned to the communication partner and the process is terminated in that step.

In this case, the communication device A sends a request to the communication device B in order to communicate therewith. In a case of conducting the communication request, a CPU of the communication device A starts a process in accordance with the flowchart shown at a left side in the FIG. 1 by executing a predetermined control program. Then, the communication device A sends a connection request to the communication device B in step S111.

On the other hand, when a CPU of the communication device B receives the connection request, the communication device B starts a process in accordance with the flowchart shown at a right side in FIG. 1 by executing a predetermined control program. In step S121, a first random number is generated, and is encrypted by using the private key B. Then, in step S122, the first random number being encrypted and the public key certificate B are sent to the communication device A.

At the communication device A, when the first random number being encrypted and the public key certificate B are received, validity of the public key certificate B is confirmed by using the root key certificate in step S112.

When the validity is confirmed, the first random number is decrypted by using the public key B included in the public key certificate B received from the communication device B in step S113. If the first random number is successfully decrypted, it can be confirmed that the first random number is surely received from an issuance subject of the public key certificate B.

After that, a second random number other than the first random number and a seed of a shared key are generated in step S114. For example, the seed of the shared key can be created based on data exchanged with the communication device B during the intercommunication. Then, the second random number is encrypted by using the private key A and the seed of the shared key is encrypted by using the public key B in step S115. In step S116, the second random number and the seed of the shared key are sent with the public key certificate A to the communication device B. The seed of the shared key is encrypted, so that any device other than the communication partner cannot recognize the seed of the shared key.

Moreover, in step S117 following to the step S116, a shared key is generated from the seed of the shared key generated in the step S114, in order to use to encrypt for further communications.

At the communication device B, when data sent from the communication device A in step S116 is received, the validity of the public key certificate A is confirmed by using the root key certificate in step S123. When the validity is confirmed, the second random number is decrypted by using the public key A included in the public key certificate A received from the communication device A in step S124. When the second random number is successfully decrypted, it can be confirmed that the second random number is surely received from an issuance subject of the public key certificate A.

After that, in step S125, the seed of the shared key is decrypted by using the private key B. By processes previously conducted, the communication device A and the communication device B share the seed of the shared key with each other. Also, the seed of the shared key cannot be known to any device other than the communication device A which generated the seed of the shared key and the communication device B which possesses the private key B. When the above conducted processes are successful, the shared key is generated from the seed of the shared key decrypted and obtained in step S126, in order to use for further communications.

Subsequently, when a process in the step S117 at the communication device A and a process in the step S126 at the communication device B are completed, the communication devices A and B mutually confirm the successful authentications and an encryption method for the further communications. Accordingly, the communication devices A and B start to communicate with each other in accordance with the encryption method by using the shared key generated at each side of the communication devices A and B, and terminate the processes concerning the authentication. While the communication devices A and B mutually confirm the successful authentications and an encryption method for the further communications, the communication devices A and B send a response showing the successful authentication. By the above-described process, the communication devices A and B establish communication with each other. In the following communications, the communication devices A and B use the shared key generated in the step S117 and S126, respectively, and can communicate with each other by encrypting data in the encryption method using the shared key.

By conducting the above-described processes, the communication devices A and B authenticate each other first, and then share the shared key so as to establish a path to securely communicate with each other.

In a case of applying a one-way authentication, for example, if only the communication device B may authenticate the communication device A, it is possible to omit the encryption of the first random number and the transmission of the first random number in the authentication process shown in FIG. 1. In this case, in order to securely send the seed of the shared key from the communication device A to the communication device B, an encryption using the public key B of the communication device B may be conducted, but it is not necessary to confirm the validity of the digital signature attached to the public key B. Accordingly, the authentication in this case can be simplified as shown in FIG. 3. That is, the steps S112 and S113 at the communication device A are not required, and the step S121 at the communication device B is not required. Also, other processes can be partially simplified.

In the above-described authentication process, contents being encrypted with the public key are decrypted by only a device having the private key corresponding to the public key, and contents being encrypted with the private key are decrypted with only the public key corresponding to the private key. Due to this feature, the communication partner authenticates that the public key certificate describes the device as an issuance destination (or the public key certificate describes a user as the issuance destination).

Japanese Laid-Open Patent Applications No. 2003-348068 (paragraph 0004) and No. 2002-190796 disclose technologies related to a management of the public key used for the authentication process.

The Japanese Laid-Open Patent Application No. 2003-348068 discloses to implement a key registration device on a network and to manage a public key, so as to reduce a workload of a user.

The Japanese Laid-Open Patent Application No. 2002-190796 discloses to automatically register necessary public keys only to a public key database of an electronic mail apparatus and to automatically manage so as to maintain only valid public keys in a case of using a public key encryption in order to encrypt an electronic mail.

However, in a public key encryption method, disadvantageously; the private key can be obtained from the public key if spending sufficient time depending on a key length. Accordingly, if the private key is recognized, a third party can pretend to be an owner of the private key. Thus, reliability of the authentication and security of the communication cannot be maintained. Thus, the number of users, who applies a security policy of providing a validated date and update a key set at predetermined period as described above, increases. Therefore, for example, in a case of providing the remote management system using the mutual authentication as described above, it is required to guarantee to a customer that the key can be updated.

Also, a third party organization provides a service for issuing the public key certificate. However, since the security is concerned, a valid term of the public key certificate issued by the third party organization is shorter, for example, one through three years. After the valid term passes, the authentication with respect to a certification is failed. In a case of using the public key certificate issued by the third party organization, it is required to update the public key certification before the valid term passes.

It should be noted that the Japanese Laid-Open Patent Applications No. 2003-348068 and No. 2002-190796 disclose only the technologies in that the public key of a sender device is simply managed by corresponding to information of the sender device and checking the validity of the public key, but do not disclose to issue a new public certificate.

As a method for distributing a new public key certificate to update to a communication device, which is to be authenticated by using the public key certificate, the CA issues a new public key certificate and a new private key to the communication device before the validated date of the public key certificate in use is expired, and the CA or a management apparatus taking the place of the CA send and set the root key certificate in addition to the public key certificate and the private key to a device of an update subject through a communication path using the SSL, which is established by using the public key certificate in use.

In this manner, the communication device can automatically update the public key certificate and the like used for the authentication before the validated date is expired. Therefore, without any trouble to the user of the communication device, it is possible to maintain the communication device to be in a state possible for the authentication. Moreover, in a case of conducting a transmission through the Internet, it is possible to conduct the transmission of the public key certificate and the like while maintaining the communication path to be secured.

However, even though the communication path is maintained to be secured by using the SSL, in a case of communication through the Internet, since information may be transferred through several servers, a possibility of spying and falsifying of the information to transfer cannot be completely eliminated. If the private key is spied, spoofing can be possible. Thus, it is desired to eliminate a risk such as spoofing even if the risk has less possibility.

### SUMMARY OF THE INVENTION

It is a general object of the present invention to provide apparatuses in which the above-mentioned problems are eliminated.

A more specific object of the present invention is to provide a certificate transmission apparatus, a communication system certificate transmission method, and a computer-executable program product and a computer-readable recording medium thereof, in which the communication device can automatically update the public key certificate used for an authentication, possibility of leaking the private key is reduced, and a secured update can be realized.

The above objects of the present invention are achieved by a certificate transmission apparatus, including: a receiving part receiving a public key created by a sender device; an examination part examining the sender device of the public key; and a sending part sending a public key certificate including the public key received by the receiving part to the sender device of the public key.

In the certificate transmission apparatus, a certificate creation part creating the public key certificate by additionally providing a digital signature to the public key received by the receiving part may be included.

Furthermore, the certificate creation part may include a part describing identification information of the sender device of a received public key certificate to the public key certificate which is to create, the identification information being described in the received public key certificate

Furthermore, he examination part may examine the sender device by using a received public key certificate in order to establish a communication path when the public key is received from the sender device of the public key.

Moreover, the public key certificate used for an examination conducted by the examination part may be a public key certificate set to the sender device when the sender device is manufactured

Also, the examination part may include a part conducting the examination of the sender device by using identification information of the sender device of a received public key certificate, the identification information is described in the received public key certificate.

Furthermore, the sending part may include a part sending the publication key certificate and a certificate key for confirming a validity of the public key certificate when the public key certificate is sent.

Moreover, the above objects of the present invention are achieved by a communication system, including: a certificate transmission apparatus; and a communication device, wherein: the certificate transmission apparatus includes: a receiving part receiving a public key; an examination part examining a sender device of the public key; and a sending part sending a public key certificate including the public key received by the receiving part to the sender device of the public key, when the sender device passes an examination conducted by the examination part, and the communication device includes: a first part generating the public key and a private key, which are to be a pair; a second part sending the public key generated by the first part; and a third part receiving the public key certificate from the certificate transmission apparatus.

In the communication system, the certificate transmission apparatus may include a certificate creation part creating the public key certificate by additionally providing a digital signature to the public key received by the receiving part.

Furthermore, the certificate creation part of the certificate transmission apparatus may include a part describing identification information of the sender device of a received public key certificate in another public key certificate, which is to create, the identification information being described in the received public key certificate.

Furthermore, the examination part of the certificate transmission apparatus may examine the sender device by using a received public key certificate in order to establish a communication path when the public key is received from the sender device of the public key, and the communication device may include a fourth part sending the public key certificate, which is possessed by the communication device, to the certificate transmission apparatus in order to establish the communication path when the public key is sent to the certification transmission apparatus.

Moreover, the public key certificate, which the communication device sends to the certificate transmission apparatus in order to establish the communication path, may be a public key certificate set to the communication device when the communication device is manufactured.

Moreover, the examination part of the certificate transmission apparatus may includes a part conducting an examination of the sender device by using identification information of the sender device of a received public key certificate, the identification information described in the received public key certificate.

Furthermore, the sending part of the certificate transmission apparatus may include a part sending the public key certificate and a certificate key for confirming a validity of the public key certificate when the public key certificate is sent.

Moreover, the above objects of the present invention are achieved by a certificate transmission method, including the steps of: receiving a public key created by a sender device; examining the sender device of the public key; and sending a public key certificate including the public key received in receiving the public key, to the sender device, when the sender device passes an examination conducted in examining the sender device.

In the certificate transmission method, the public key certificate may be created by additionally providing a digital signature to the public key received in receiving the public key.

Furthermore, the creating the public key certificate may include the step of describing identification information of the sender device of a received public key certificate to the public key certificate to be created in creating the public key certificate, the identification information described in the received public key certificate.

Furthermore, in examining the sender device, an examination of the sender device may be examined by using the public key certificate being receive, to establish a communication path when the public key is received from the sender device of the public key.

Moreover, the public key certificate used in the examination in examining the sender device may be a public key certificate set to the sender device of the public key when the sender device is manufactured.

Moreover, the examining the sender device may include the step of conducting the examination of the sender device by using identification information of the sender device of a received public key certificate, the identification information described in the received public key certificate.

Furthermore, the sending the public key certificate may include the step of sending the public key certificate and a certificate key for confirming a validity of the public key certificate when the public key certificate is sent.

The above objects of the present invention can be achieved by a computer-executable program product for causing a computer to send a public key certificate, including program code for: receiving a public key created by a sender device; examining the sender device of the public key; and sending a public key certificate including the public key received in receiving the public key, to the sender device, when the sender device passes an examination in the examining the sender device.

Moreover, the computer-executable program product may further include program code for creating the public key certificate by additionally providing a digital signature to the public key received in the receiving the public key.

Furthermore, the creating the public key certificate may include program code for describing identification information of the sender device of a received public key certificate to the public key certificate to be created, the identification information described in the received public key certificate.

Furthermore, in examining the sender device, the sender device may be examined by using the received public key certificate in order to establish a communication path when the public key is received from the sender device of the public key.

Moreover, the public key certificate used to examine the sender device in examining the sender device may be a public key certificate set to the sender device when the sender device is manufactured.

Furthermore, the examining the sender device may include the program code for conducting an examination of the sender device by using identification information of the sender device of the received public key certificate, the identification information described in the received public key certificate.

Moreover, the sending the public key certificate may include the program code for sending the public key certificate and a certificate key for confirming a validity of the public key certificate when the public key certificate is sent.

Moreover, the above objects of the present invention are achieved by a computer-readable recording medium recorded with a program for causing a computer to send a public key certificate, the program including codes for: receiving a public key created by a sender device; examining the sender device of the public key; and sending a public key certificate including the public key received in receiving the public key, to the sender device, when the sender device passes an examination in the examining the sender device.

### BRIEF DESCRIPTION OF THE DRAWINGS

In the following, embodiments of the present invention will be described with reference to the accompanying drawings.

FIG. 1 is a diagram showing a flowchart of a process executed by each device with information used for the process when two communication devices conduct a mutual authentication with accordance with an SSL;

FIG. 2A and FIG. 2B are diagrams for explaining relationships among a root key, a root private key, and a public key certificate in an authentication process shown in FIG. 1;

FIG. 3 is a diagram showing a process executed by each device when two communication devices conduct a one-way authentication in accordance with the SSL, corresponding to the mutual authentication in FIG. 1;

FIG. 4 is a diagram showing a configuration example of a communication system according to an embodiment of the present invention;

FIG. 5 is a block diagram showing a hardware configuration of a management apparatus shown in FIG. 4 according to the embodiment of the present invention;

FIG. 6 is a block diagram showing a functional configuration of portions related to features of the present invention in the management apparatus and a management subject device according to the embodiment of the present invention;

FIG. 7A is a diagram for explaining a certificate and a key used for an authentication process at the management subject device shown in FIG. 4 and FIG. 6, according to the embodiment of the present invention and FIG. 7B is a diagram for explaining a certificate and a key used for an authentication process at the management apparatus shown in FIG. 4 and FIG. 6, according to the embodiment of the present invention;

FIG. 8 is a diagram for explaining a format example of a public key certificate for authenticating the management subject device shown in FIG. 7A and FIG. 7B, according to the embodiment of the present invention;

FIG. 9 is a diagram showing a public key certificate example for authenticating the management subject device in accordance with the format shown in FIG. 8, according to the embodiment of the present invention;

FIG. 10 is a block diagram showing a configuration example of equipment related to settings of a certificate, the equipment arranged in a production plant and related institutions for producing the management subject device shown in FIG. 4, according to the embodiment of the present invention;

FIG. 11 is a sequence diagram showing a process flow for setting the public key certificate and the like to the management subject device in the production plant by the equipment shown in FIG. 10, according to the embodiment of the present invention;

FIG. 12 is a diagram showing an information example for communicating with the management apparatus, the information stored in a certificate memory of the management subject device shown in FIG. 4, according to the embodiment of the present invention;

FIG. 13 is a sequence diagram showing a process flow in a case of updating the public key certificate of the management subject device in a communication system shown in FIG. 4, according to the embodiment of the present invention;

FIG. 14 is a flowchart for explaining a process at the management apparatus in a case of executing the process shown in FIG. 13, according to the embodiment of the present invention;

FIG. 15 is a diagram showing a format example of the public key which the management apparatus receives in the process shown in FIG. 14, according to the embodiment of the present invention;

FIG. 16 is a diagram showing a description example of a notice of a self-generation public key sent from the management subject device to the management apparatus as a SOAP request, according to the embodiment of the present invention;

FIG. 17 is a flowchart for explaining contents of an examination process in step S23 in FIG. 14, according to the embodiment of the present invention;

FIG. 18 is a diagram showing a database example for the public key certificate created in a certificate storage part of the management apparatus according to the embodiment of the present invention;

FIG. 19 is a diagram showing a description example of a SOAP response for a response with respect to the SOAP request shown in FIG. 16, in a case in that the examination is successful in the management apparatus according to the embodiment of the present invention;

FIG. 20 is a diagram showing another description example of the SOAP response for a response with respect to the SOAP request shown in FIG. 16, in a case in that the examination is not successful in the management apparatus according to the embodiment of the present invention;

FIG. 21 is a flowchart for explaining a process at the management subject device in a case of executing the process shown in FIG. 13, according to the embodiment of the present invention;

FIG. 22 is a diagram showing an information example stored in the certificate memory after update by the process shown in FIG. 13, according to the embodiment of the present invention; and

FIG. 23 is a diagram showing a system example of arranging a plurality of the management subject device in the communication system shown in FIG. 4, according to the embodiment of the present invention.

### DESCRIPTION OF THE PREFERRED EMBODIMENT

In the following, an embodiment of the present invention will be described with reference to the accompanying drawings.

First, a configuration of a certificate transmission apparatus according to the present invention and a configuration of a communication system according to the present invention, including the certificate transmission apparatus will be described according to the embodiment of the present invention.

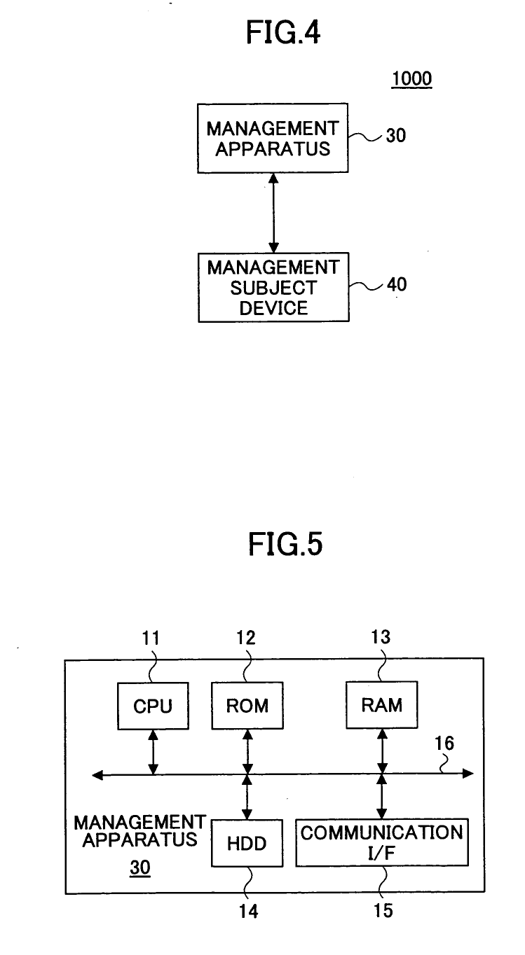

FIG. 4 shows the configuration of the communication system according to the embodiment of the present invention.

In this embodiment, a communication system 1000 includes a management apparatus 30 as the certificate transmission apparatus and a management subject device 40 as the communication device to be a communication partner. In the communication system 1000, the management apparatus 30 includes a function for managing the management subject device 40 and a function for issuing and sending a public key certificate as a digital certificate used in an authentication process with respect to the management subject device 40.

Also, in the communication system 1000, in a case of attempting to communicate with the management subject device 40, when the management apparatus 30 authenticates the management subject device 40 as a valid communication partner by conducting the authentication process in accordance with an SSL protocol, which is an authentication method using a public key encryption and the digital certificate, the management apparatus 30 establishes a communication with the management subject device 40. Subsequently, with respect to an operation request (command) sent by the management apparatus 30, the management subject device 40 conducts a necessary process and returns a response. Thus, the management apparatus 30 and the management subject device function and realize a client/server system.

On the other hand, even in a case in that the management subject device 40 attempts to communicate with the management apparatus 30, similarly, when the management apparatus 30 is authenticated as the valid communication partner by the authentication process in accordance with the SSL, the management subject device 40 establishes a communication with the management apparatus 30. With respect to an operation request (command) sent from the management subject device 40, the management apparatus 30 conducts a necessary process and returns a response to the management subject device 40. Thus, the management apparatus 30 and the management subject device function and realize the client-server system.

In either case, a side requesting a communication functions as a client and a side being requested functions as a server.

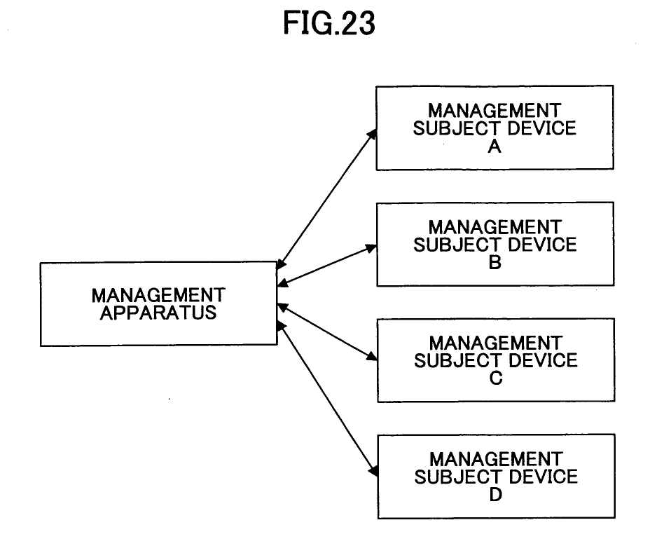

In FIG. 4, only one management subject device 40 is shown. However, as shown in FIG. 23, a plurality of the management subject devices 40 can be arranged. Also, it is not necessary for the management subject device 40 to be one type. On the other hand, one management apparatus 30 is arranged for one communication system 1000.

In the communication system 1000, in a communication between the management apparatus 30 and the management subject device 40, a “request” is sent to request a process with respect to a method of an application program, which is implemented in both the management apparatus 30 and the management subject device 40 by an RPC (Remote Procedure Call). Then, a “response” showing a result of the process, which is requested, can be obtained.

In order to realize the RPC, a well-known protocol (communication procedure), technology, and specification such as a SOAP (Simple Object Access Protocol), an HTTP (Hyper Text Transfer Protocol), an FTP (File Transfer Protocol), a COM (Component Object Model), a CORBA (Common Object Request Broker Architecture), and a like can be used.

Next, each configuration and function of the management apparatus 30 and the management subject device 40 shown in FIG. 4 will be described in detail.

The management apparatus 30 and the management subject device 40 shown in FIG. 4 can be variously configured in response to a purpose of a remote management of a device, an electronic commerce, or a like. For example, in a case of the remote management, a network home electronic device, a vending machine, a medical instrument, a power device, an air conditioning system, a measuring apparatus for gas, water, electricity, and a like, an electronic apparatus such as an automobile, an aircraft, and a like, in addition to an image processing apparatus such as a printer, a facsimile, a copier, a scanner, a digital copier or a like may be arranged as the management subject device 40 to be managed. Also, a management apparatus for collecting information from the management subject device 40 and sending a command to have the management subject device 40 operated may be arranged as the management apparatus 30. However, in any configuration case, the management apparatus 30 includes a function for sending the public key certificate to the management subject device 40 as described later.

FIG. 5 is a diagram showing a hardware configuration example of the management apparatus 30 according to the embodiment of the present invention. As shown in FIG. 5, for example, the management apparatus 30 includes a CPU (Central Processing Unit) 11, a ROM (read Only Memory) 12, a RAM (Random Access Memory) 13, an HDD (Hard Disk Drive) 14, and a communication interface (I/F) 15, which are mutually connected via a system bus 16. The CPU 11 controls operations of the management apparatus 40 by executing various control programs stored in the ROM 12 or the HDD 14, and realizes various functions such as the authentication of the communication partner, the communication with the management subject device 40, a management of the management subject device 40, an issuance and a management of the public key certificate, and a like.

Of course, a well-known computer can be approximately used as the management apparatus 30, and other hardware can be additionally mounted if necessary.

The management subject device 40 also includes a CPU, a ROM, an RAM, and a communication I/F for communicating to external devices through a network, and a storage unit for storing information necessary for the authentication process, and realizes various functions according to the present invention by the CPU executing a predetermined control program stored in the ROM.

It should be noted that for the communication between the management apparatus 30 and the management subject device 40, various types of communication lines (communication paths) capable of architecting a network can be applied, regardless of being wired or wireless.

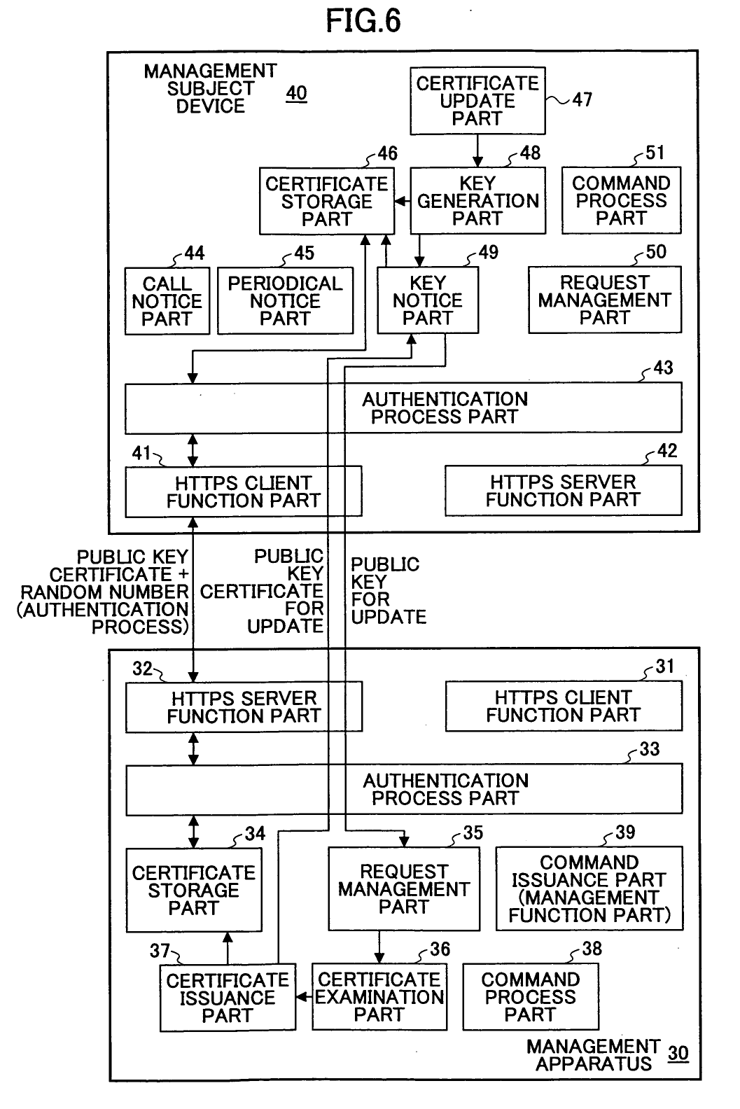

FIG. 6 is a block diagram showing a functional configuration of portions related to features of the management apparatus 30 and the management subject device 40 according to the embodiment of the present invention. It should be noted that arrows in FIG. 6 show data flows in a case of updating the public key certificate of the management subject device 40 as described later.

First, the management apparatus 30 includes an HTTPS (Hypertext Transfer Protocol Security) client function part 31, an HTTPS server function part 32, an authentication process part 33, a certificate storage part 34, a request management part 35, a certificate examination part 36, a certificate issuance part 37, a command process part 38, and a command issuance part 39.

The HTTPS client function part 31 includes a function for requesting a communication with respect to a device having a function of an HTTPS server such as the management subject device 40 by using an HTTPS protocol including the authentication process and an encryption process in accordance with the SSL.

On the other hand, the HTTPS server function part 32 includes a function for accepting a communication request using the HTTPS protocol from a device having the HTTPS client such as the management subject device 40.

Accordingly, the HTTP client function part 31 and the HTTPS server function part 32 realize a function for having the communication partner execute an operation corresponding to a command by sending the command and data to the communication partner, and a function for receiving a request and data from the communication partner and having one or more parts in the management apparatus 30 execute an operation corresponding to the command, and for returning a response showing a result to the communication partner. In this case, a side requesting the communication may send a command and a side receiving the communication request may send a command. A similar manner may be conducted for the response.

The authentication process part 33 includes a function of an authentication means for conducting the authentication process using the public key certificate received from the communication partner, various certificates stored in the certificate storage part 34, a private key, and a like when the HTTPS client function part 31 or the HTTPS server function part 32 authenticates the communication partner. In addition, in order to request an authentication to the communication partner, the authentication process part 33 includes a function for sending the public key certificate stored in the certificate storage part 34 to the communication partner through the HTTPS client function part 31 or the HTTPS server function part 32.

The certificate storage part 34 includes a function for storing authentication information such as the public key certificate, the private key, a root key certificate, and a like, and providing the authentication information to the authentication process conducted by the authentication process part 33. Also, the certificate storage part 34 includes a function for storing the public key certificate issued by the certificate issuance part 37 and information concerning an issuance destination as a database.

The request management part 35 includes a function for determining whether or not an operation based on a command received from the management subject device 40 can be executed. In a case of permitting an execution, the request management part 35 also includes a function for informing the command to a function part for executing the operation based on the command. It should be noted that as the function part for executing the operation based on the command, only the certificate execution part 36 and the certificate issuance part 37 are shown in detail, and function parts other than the certificate execution part 36 and the certificate issuance part 37 are collectively shown as the command process part 38.

The certificate execution part 36 includes a function for executing whether or not the public key certificate is issued to a communication partner as a sender when an update public key is received from the communication partner. The certificate issuance part 37 includes a function for issuing an update public key certificate by additionally providing a digital signature to the update pubic key received from the communication partner, and sending the update public key certificate to the communication partner. It should be noted that the certificate issuance part 37 further includes a function for issuing the public key certificate, which is stored in the management subject device 40 at a production plant, which will be described later.

The command process part 38 includes a function for executing an operation corresponding a request to a function other than the certificate execution part 36 and the certificate issuance part 37. This operation can be, for example, an operation for handling an abnormal occurrence notice from the management subject device 40, an operation for sending data stored in the management apparatus 30 in response to a request received from the management subject device 40.

The command issuance part 39 includes a function for issuing various commands to the management subject device 40 and having the management subject device 40 execute an operation in accordance with an issued command. The operation executed by the management subject device 40 can be an operation for sending information concerning an operation content and a setting state of the management subject device 40, an operation for storing information sent from the management apparatus 30, an operation for conducting a setting change based on the information, or a like. The command issuance part 39 includes a function for causing the management subject device 40 to execute various operation in accordance with information obtained from the management subject device 40, so as to manage the management subject device 40.

The above-described functions can be realized by the CPU of the management apparatus 30 controlling operations of each part of the management apparatus 30 by executing the predetermined control program.

Next, the management subject device 40 includes an HTTPS client function part 41, an HTTPS server function part 42, an authentication process part 43, a call notice part 44, a periodical notice part 45, a certificate storage part 46, a certificate update part 47, a key generation part 48, a key notice part 49, a request management part 50, and a command process part 51.

The HTTPS client function part 41 includes a function for requesting a connection to an apparatus including the HTTPS server function such as the management apparatus 30 using the HTTPS protocol, and for sending a command and receiving a response, similar to the HTTPS client function part 31 of the management apparatus 30.

The HTTPS server function part 42 also includes a function for receiving the communication request from the apparatus having the HTTPS client function, and sending a command and receiving a response, similar to the HTTPS server function part 32 of the management apparatus 30.

The authentication process part 43 also includes a function similar to the authentication process part 33 of the management apparatus 30, but stores a certificate and a like used for the authentication process in the certificate storage part 46.

The call notice part 44 includes a function for conducting a call to send a notice to the management apparatus 30 when an abnormal state is detected or a user made an instruction.

The periodical notice part 45 includes a function for sending a periodical notice from the management subject device 40 to the management apparatus 30. A content of the notice may be, for example, a count value of an image formation counter if the management subject device 30 is an image forming apparatus, a meter value if the management subject device 30 is a meter system.

The certificate storage part 46 includes a function of a certificate storing means for storing the authentication information such as various certificates, private keys, and a like, and providing the authentication information to the authentication process conducted by the authentication process part 43, similar to the certificate storage part 34 of the management apparatus 30. However, the certificates and the like stored by the certificate storage part 46 are different form the certificates and the like stored in the certificate storage part 34.

The certificate update part 47 includes a function for having the key generation part 48 and the key notice part 49 conduct an update when a validated date of the public key certificate used for the authentication process for the management apparatus 30 in all public key certificates stored in the certificate storage part 46 is closer to be expired.

Then, the key generation part 48 includes a function for generating a set of the update public key and an update private key as a pair of keys to update, in accordance with a predetermined algorithm, storing the update private key to the certificate storage part 46, and passing the update public key to the key notice part 49 to send it to the management apparatus 30.

The key notice part 49 includes a function for sending the update public key generated by the key generation part 48 to the management apparatus 30, receiving an update public key certificate returned with the digital signature from the management apparatus 30, storing the update public key certificate to the certificate storage part 46 by a correspondence to the update private key, and setting the set of the update public key certificate and the update private key to use for the authentication process with the management apparatus 30.

The request management part 50 includes a function for determining whether or not an operation based on a command can be executable for the command received from the management apparatus 30. Also, the request management part 50 further includes a function for informing the command to a function part for executing an operation based on the command in the command process part 51.

The command process part 51 includes a function for executing an operation in response to the command received from the management apparatus 30. The operation can be, for example, to send data stored in the management subject device 40, to control an operation of an engine part (not shown) if necessary, or a like.

Each function of the above-described parts can be realized by the CPU of the management subject device 40 controlling each operation of the above-described parts of the management subject device 40 by executing the predetermined control program.

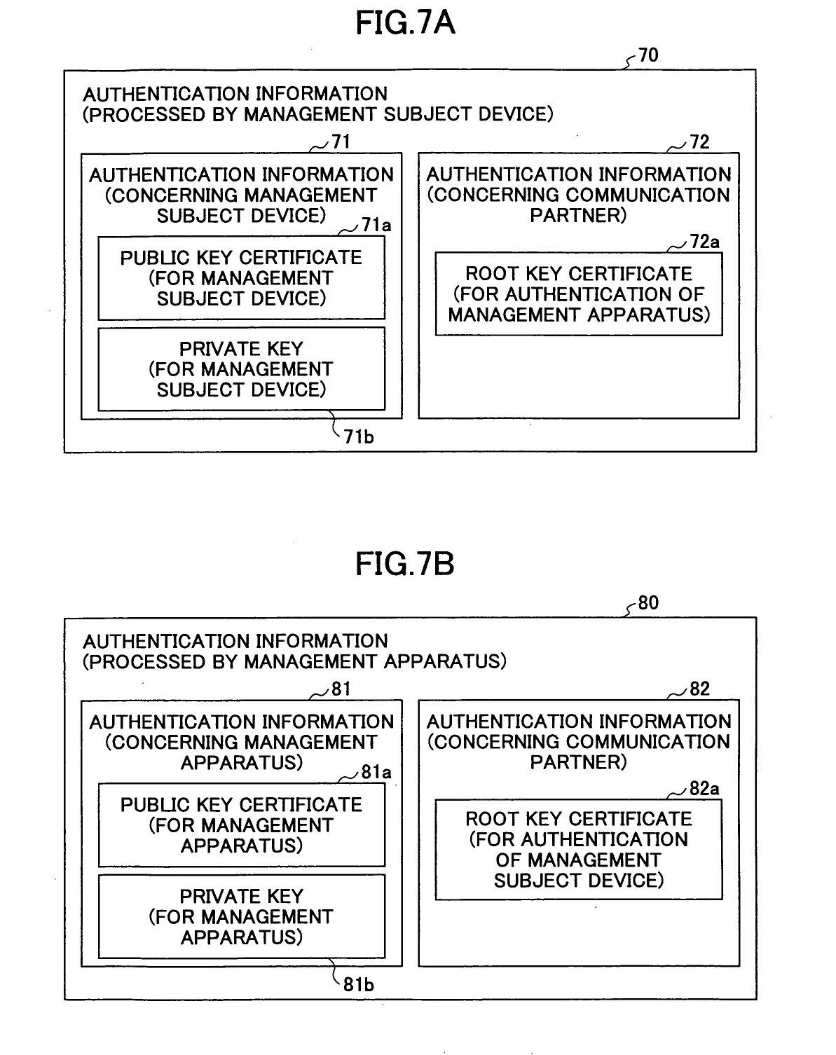

Next, FIG. 7A and FIG. 7B are diagrams showing types of the certificates and keys used for the authentication processes by the management apparatus 30 and the management subject device 40 according to the embodiment of the present invention. FIG. 7A shows types of the certificates and keys stored in the certificate storage part 46 of the management subject device 40, and FIG. 7B shows types of the certificates and keys stored in the certificate storage part 34 of the management apparatus 30. In FIG. 7A and FIG. 7B, the certificates and keys used for the authentication processes only for the management apparatus 30 and the management subject device 40 are shown.

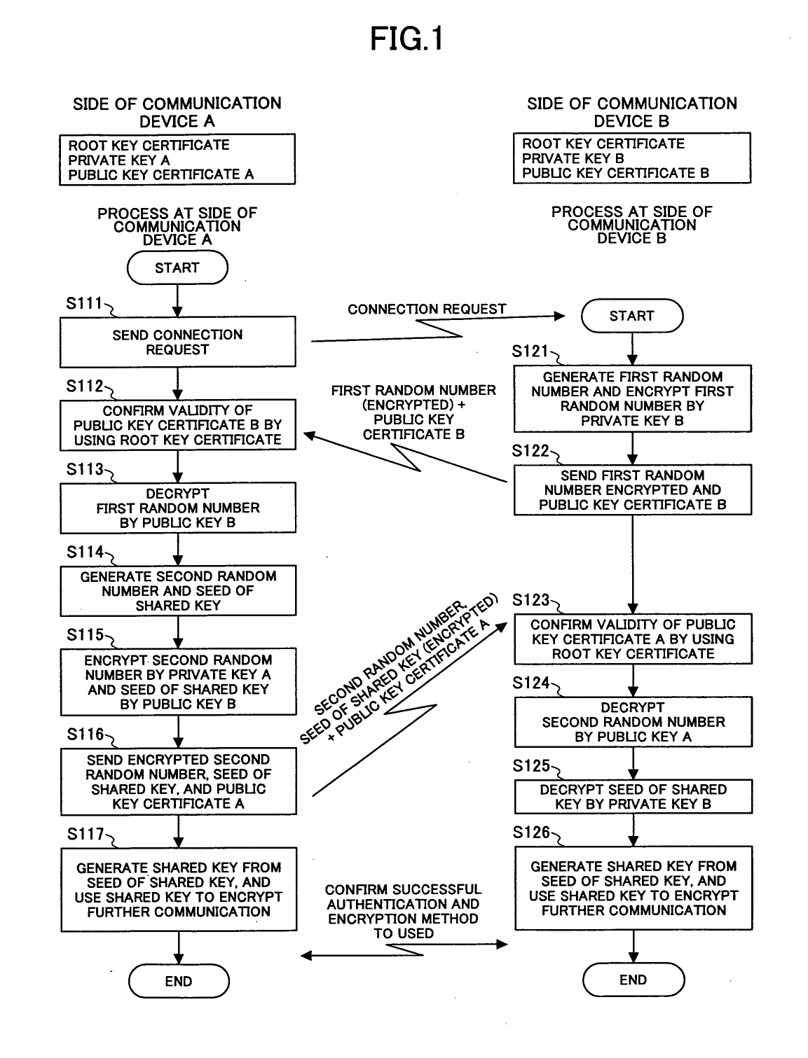

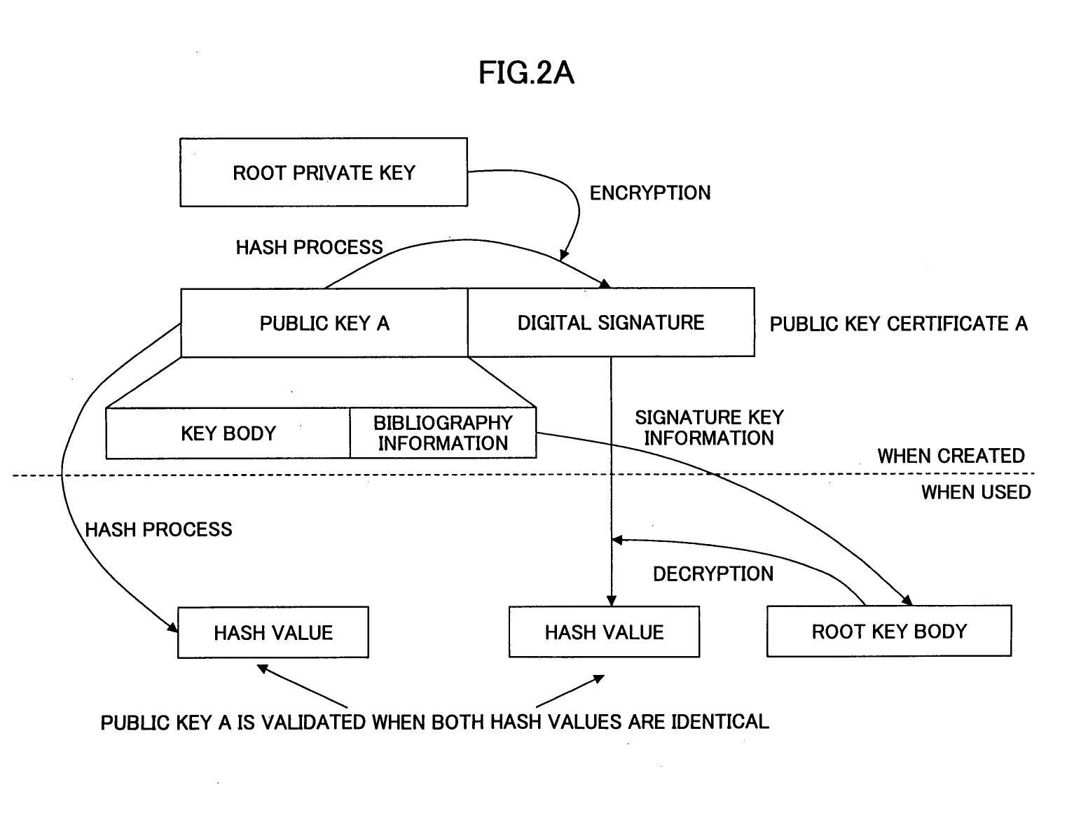

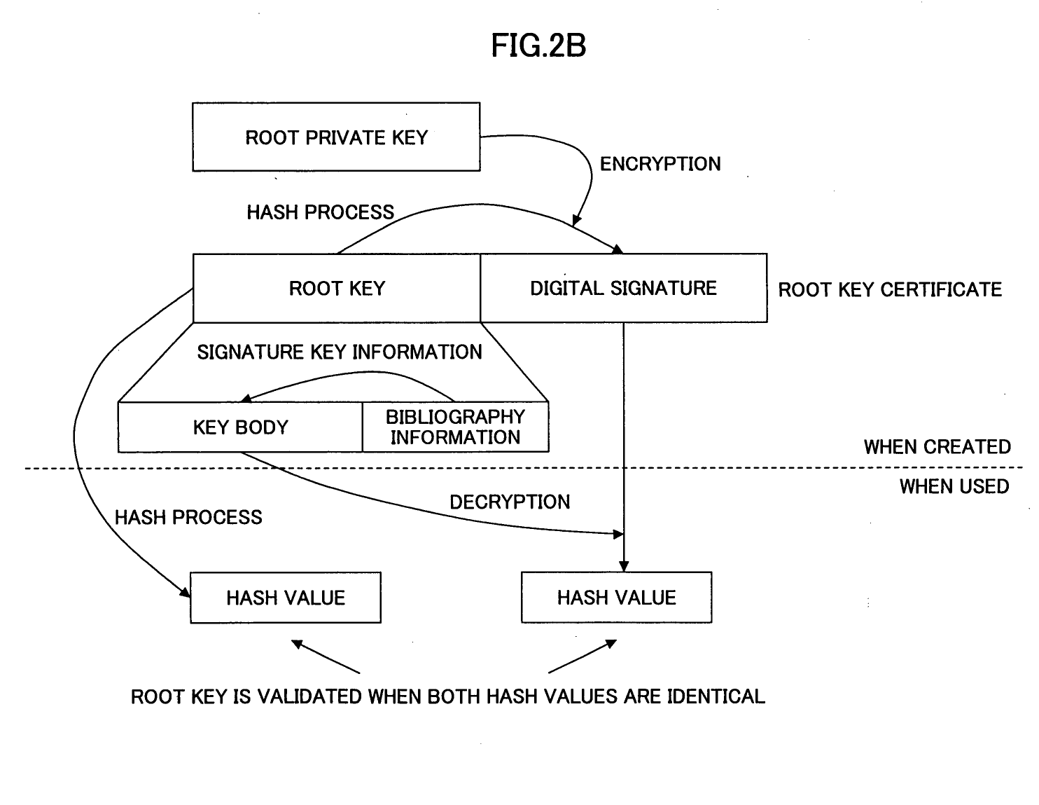

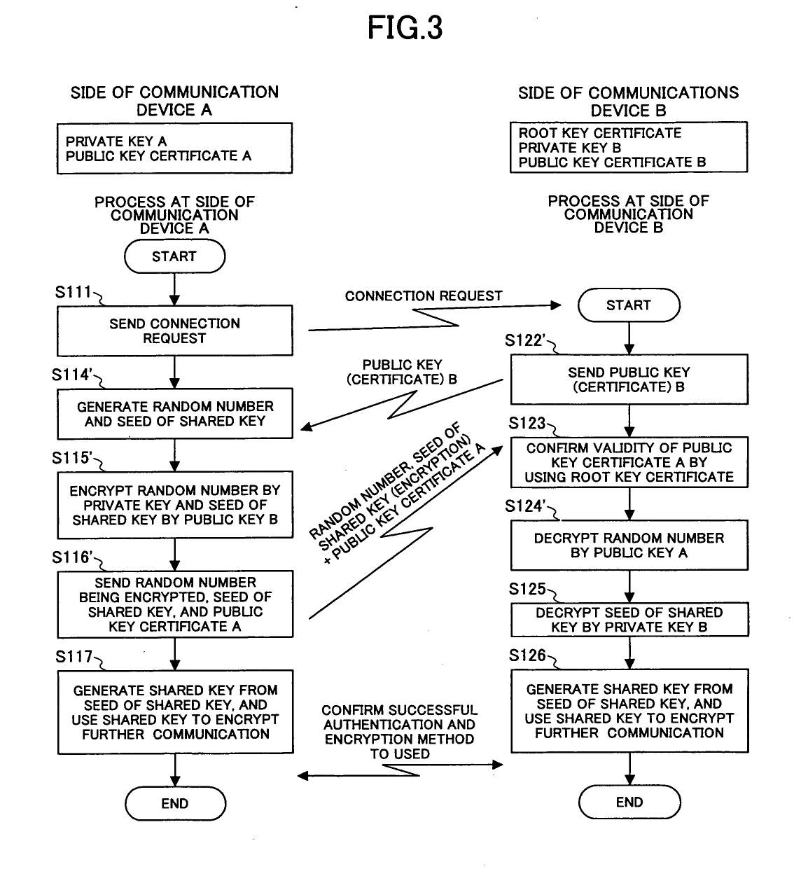

As shown in FIG. 7A, the management subject device 40 stores authentication information 70 including a public key certificate 71a for the management subject device 40 and a private key 71 b for the management subject device 40 as authentication information 71 concerning the management subject device 40 and a root key certificate 72a for authenticating the management apparatus 30 as authentication information 72 concerning the management apparatus 30 as a communication partner. As shown in FIG. 7B, the management apparatus 30 stores authentication information 80 including a public key certificate 81a for the management apparatus 30 and a private key 81 b for the management apparatus 30 as authentication information 81 concerning the management apparatus 30 and a root key certificate 82a for authenticating the management subject device 40 as authentication information 82 concerning the management subject device 40 as a communication partner. Each of the management apparatus 30 and the management subject device 40 conducts the mutual authentication by a procedure shown in FIG. 1 or the one-way authentication by a procedure shown in FIG. 3 in accordance with the SSL with its communication partner using its authentication information during a normal communication.

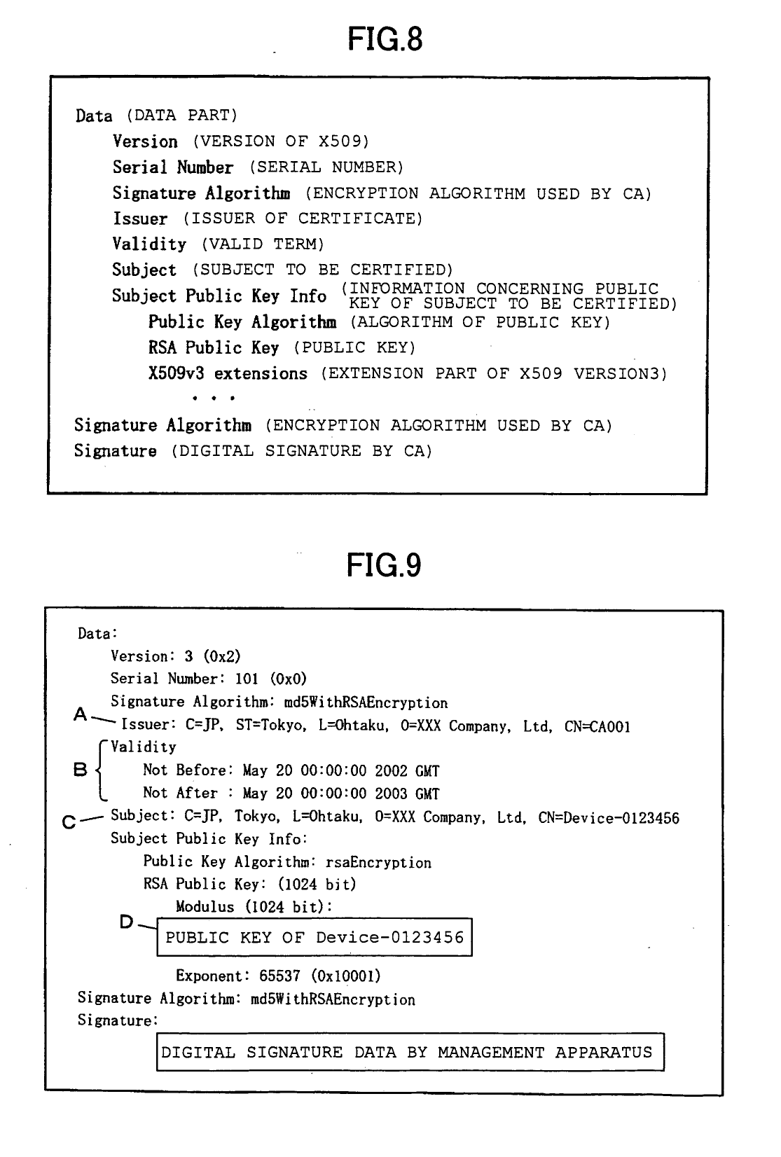

In this case, for example, a format of the public key certificate shown in FIG. 8 can be used. In addition to the public key itself, in the format, information such as an issuer of a certificate, a validated date of the certificate, a subject (a device or a user as an issuance destination of the certificate) to be certified, and a like are described. In detail, for example, the public key certificate can be created in accordance with a format called an X.509 format.

FIG. 9 is a diagram showing a public key certificate example for the management subject device 40, which is created in accordance with the X.509 format.

In the public key certificate example, a reference sign A shows identification information of the management apparatus 30 which issued the public key certificate (in which the digital signature is additionally provided to the public key), and a reference sign C shows identification information of the management subject device 40 as an issuance destination of the certificate. Each identification information includes information such as a location, a name, a device number or a code, and a like. However, it is not mandatory to describe the identification information possible to identify each device such as the device number for a device as the issuance destination. In addition, a reference sign B shows the valid term by indicating a start date and an end date. A reference sign D shows a public key body.

Moreover, the private key for the management subject device 40 is a private key corresponding to the public key for the management subject device 40, and the root key certificate for the management subject device 40 is a digital certificate to which the digital signature capable of confirming the validity by itself by using the root private key corresponding to itself is additionally provided to the root key for authenticating the management subject device 40.

In a case of providing a plurality of the management subject devices 40, the digital signature is additionally provided to the public key for the management subject device 40 for each device by using the same root private key, and the root key certificate necessary to confirm the validity thereof is shared. However, the public key included in the public key certificate for the management subject device 40 and the private key corresponding to the public key are different for each device.

A public key certificate for the management apparatus 30, a private key for the management apparatus 30, and the root key certificate for authenticating the management apparatus 30 have a similar relationship.

For example, in a case in that the management apparatus 30 and the management subject device 40 conduct the mutual authentication, in response to a communication request from the management subject device 40, the management apparatus 30 sends a first random number encrypted by using the private key for the management apparatus 30 to the management subject device 40 with the public key certificate for the management apparatus 30. First, the management subject device 40 confirms the validity (showing no compromise and no falsification) of the public key certificate for the management apparatus 30 by using the root key certificate for authenticating the management apparatus 30. When the validity is confirmed, the management subject device 40 decrypts the first random number by using the public key included in the public key certificate. In a case in that this decryption is successful, the management subject device 40 can surely recognize that the management apparatus 30 as the communication partner is the issuance destination of the public key certificate for the management apparatus 30, and can specify the management apparatus 30 from the identification information included in the public key certificate. Accordingly, it is possible for the management subject device 40 to check whether or not a specified apparatus is suitable for the communication partner and to determine whether or not the authentication is successful or failed base on a check result.

Moreover, the management apparatus 30 receives the public key certificate for the management subject device 40 and a random number encrypted by using the private key for the management subject device 40, which are sent when the authentication is successful at the management subject device 40, and then conducts a similar authentication by using the root key certificate for the management subject device 30 stored in the management apparatus 30.

This procedure is conducted when the management subject device 40 requests a communication to the HTTPS server function part 32 of the management apparatus 30 by the HTTPS client function part 41. In a case in that the management apparatus 30 requests a communication to the HTTPS server function part 42 of the management subject device 40 by the HTTPS client function part 31, the same certificate and key are used, but the processes of the management apparatus 30 and the management subject device 40 are opposite to each other.

In order to conduct the above-described process, it is required to set the public key certificates and keys as shown in FIG. 7A and FIG. 7B to the management apparatus 30 and the management subject device 40, so as to conduct the authentication processes, respectively. Since the management apparatus 30 can issue the public key certificate and the root key certificate by itself, the management apparatus 30 may set the public key certificate and the root key certificate by itself.

However, it is required to set the authentication information 70 for each management subject device 40. Moreover, if the public key certificate describing a device number of the management subject device 40 as the identification information is used, it is required to issue and set the public key certificate corresponding to each device. This setting can be conducted at a production plant when the management subject device 40 is produced.

In the following, a procedure of equipment and settings will be described.

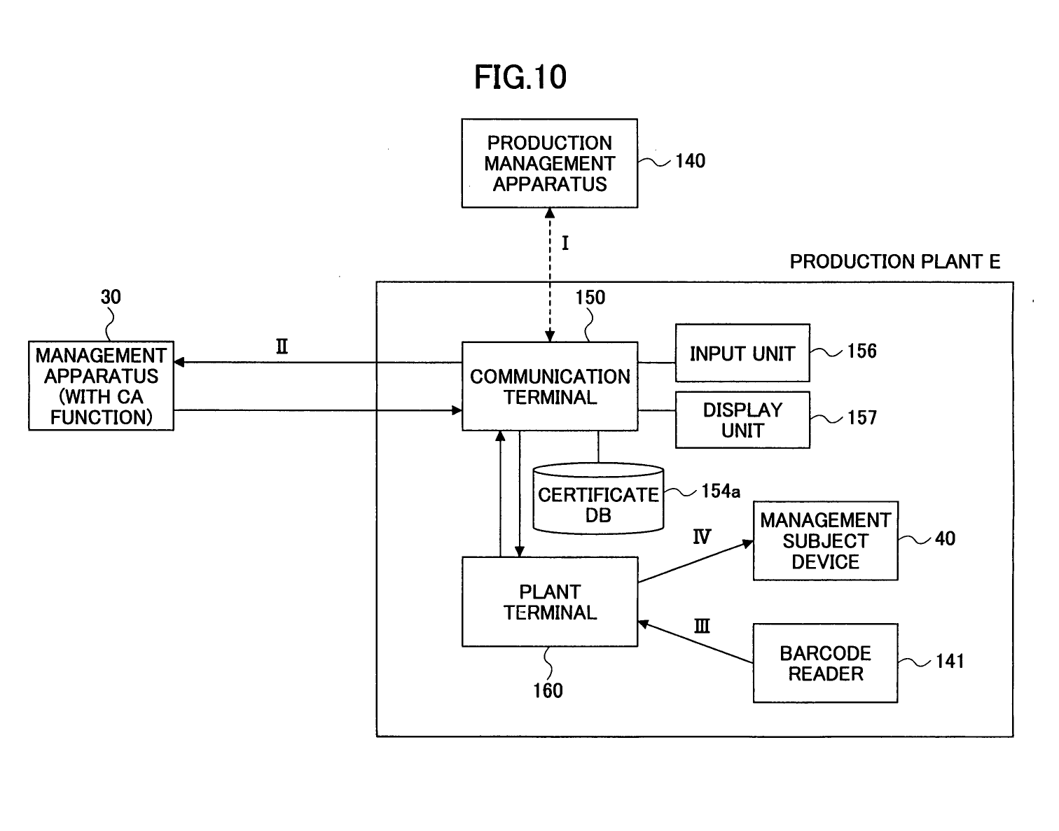

FIG. 10 is a block diagram showing a configuration example of equipment associated with the settings of the certificate, which is installed in the production plant and related facilities for producing the management subject device 40, according to the embodiment of the present invention.

As shown in FIG. 10, in a production plant E for producing the management subject device 40, a communication terminal 150 and a plant terminal 160 are equipped. Moreover, as the related facilities, a production management apparatus 140 is equipped, and the management apparatus 30 is equipped as a CA for issuing the public key certificate, which is to be stored in the management subject device 40.

In this configuration, the production management apparatus 140 is an apparatus for making and managing a production plan of a device of a manufacturer, and is also used to manage the number of daily productions of the management subject device 40, and the like. Then, the management apparatus 30 includes functions for issuing providing a signature to, and managing the public key certificate and the private key, The communication terminal 150 communicates with an external device outside the production plant E. This communication can be conducted using various networks. Then, in a case of using the Internet, security is maintained by a proper method such as the SSL. The communication terminal 150 includes functions for obtaining information showing the number of daily productions of a communication device for each device type by communicating with the production management apparatus 140, and obtaining a certification set as shown in FIG. 7A including the device type and the device number, which are to be attached to each device scheduled to be produced.

In addition, a certificate database (DB) 154a is stored in a hard disk drive (HDD) of the communication terminal 150. An input unit 156 and a display unit 157 are a keyboard, a display, and a like for an input and output, respectively.

A barcode reader 141 is a small size barcode reader being a handheld type for reading information of a barcode showing the device number (identification information) printed on a rated faceplate or a respective check sheet pasted to the device produced in the production plant E, and sending the information of the barcode to the plant terminal 160.

Then, when the device number is input to the plant terminal 160, the plant terminal 160 obtains the certificate corresponding to the device number from the communication terminal 150, and sends the certificate to a respective management subject device 40. The certificate is written in a non-volatile memory in the management subject device 40. One or more plant terminals 160 are equipped in the production plant E.

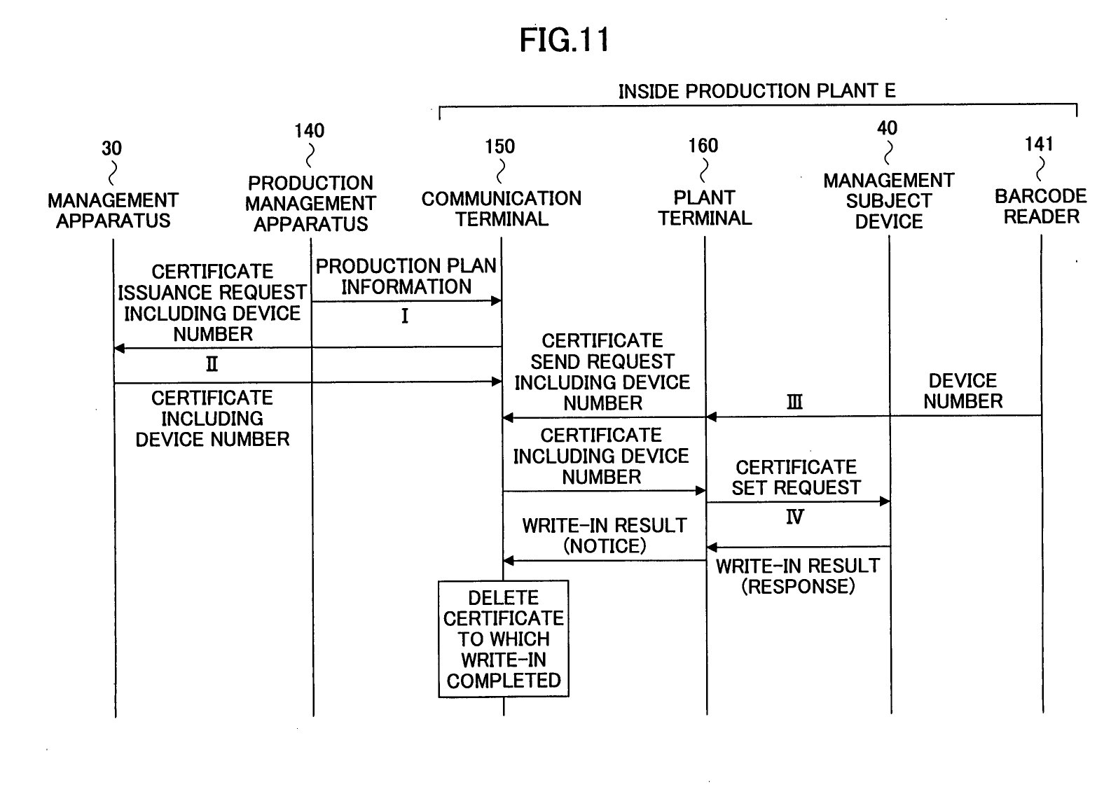

Next, FIG. 11 is a sequence diagram showing a process flow for setting the public key certificate and the like to the management subject device 40 by using the equipment shown in FIG. 10 in the production plant E. In FIG. 11, Roman numbers such as I, II, III, IV, . . . , correspond to Roman numbers shown in FIG. 10.

In a case of producing the management subject device 40 in the production plant E, as shown in FIG. 11, first, at a predetermined date and time, the communication terminal 150 obtains information such as a device code list for the devices being produced in the production plant E, the number of scheduled daily productions for each device type, and a like from the production management apparatus 140 (I).

Moreover, at a predetermined time for each day, the communication terminal 150 generates a certificate issuance request for requesting to send an individual certificate set to set in each communication device on a production schedule on a current day, based on the information obtained from the production management apparatus 140.

After that, in response to the certificate issuance request, the management apparatus 30 creates the certificate set, in which the public key certificate is included in the device information received with the certificate issuance request, for each of the device number information, and sends the certificate set to the communication terminal 150. Then, the communication terminal 150 receives the certificate set and stores the certificate set in the certificate DB 154a (II).

Next, the management subject device 40 is assemble data production line. After the management subject device 40 is checked, the device number is provided to and the rated faceplate is pasted to the management subject device 40. After that, the management subject device 40 advances to a setting step for the individual certificate, an operator connects the management subject device 40 to the plant terminal 160 through a write I/F, reads the barcode of the rated faceplate by using the barcode reader 141, and inputs the device number to the plant terminal 160 (III).

Then, the plant terminal 160 requests the communication terminal 150 to send the certificate set including the device number. In response to this request, the communication terminal 150 reads out the certificate set, in which a device number identical to the device number indicated by the operator is included in the public key certificate, from the certificate DB 154a, and sends the certificate set to the plant terminal 160.

When the plant terminal 160 receives the certificate set, the plant terminal 160 requests the management subject device 40 of which the device number is read out and which is connected through the write I/F, to set the certificate set received from the communication terminal 150 as a certificate set to use for an authentication with the management apparatus 30 (IV).

On the other hand, when the management subject device 40 receives this request from the plant terminal 160, the management subject device 40 writes the certificate set received with this request in a certificate memory, and sends a result to the plant terminal 160.

Moreover, the communication terminal 150 may periodically check and delete the certificate which is completely set in the management subject device 40 in the above-described steps.

By processes described above, the communication terminal 150 obtains a necessary quantity of the certificate sets, each certificate set including information showing the device type and device number, from the management apparatus 30 in accordance with the production schedule obtained from the production management apparatus 140, and sets each certificate set to each management subject device 40 being produced, through the plant terminal 160.

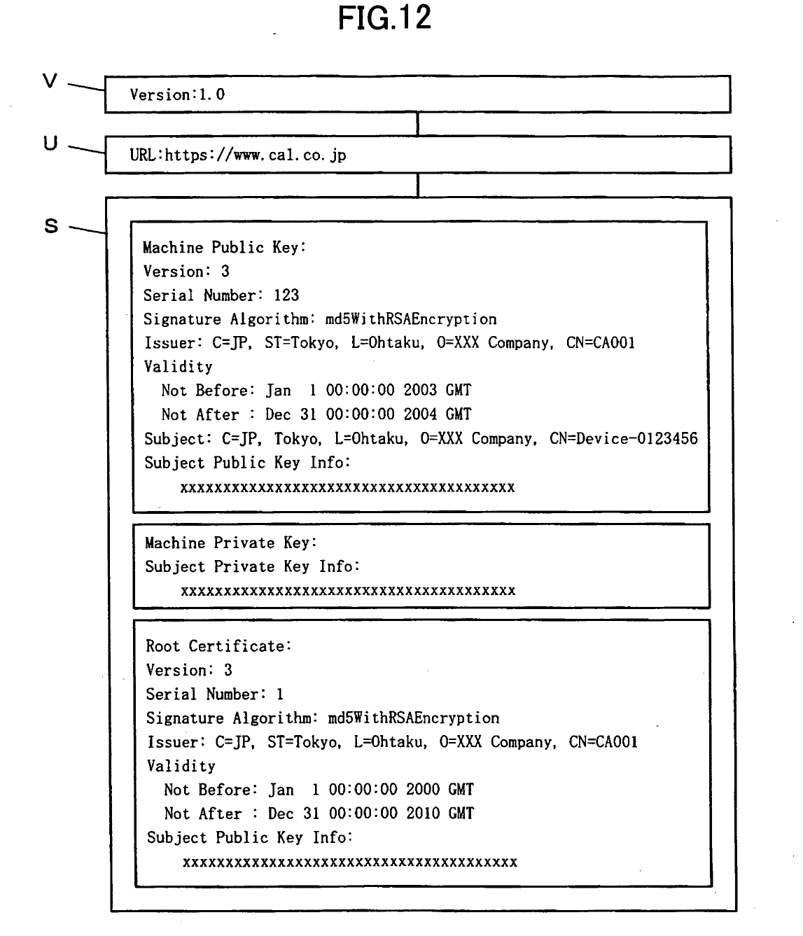

In this case, the certificate memory of the management subject device 40 stores information as shown in FIG. 12 as information for communicating with the management apparatus 30. That is, the certificate memory stores a certificate set S, communication destination information U used to request the management apparatus 30 as the communication partner for conducting the authentication process using the public key certificate included in the certificate set, to communicate with each other, and version information U showing a version of the public key certificate included in the certificate set S.

It should be noted that the communication destination information U is described, for example, as an URL (Uniform Resource Locator), but it is not limited to the URL. Unless correspondences among the certificate set S, the communication destination information U, and the version information U are prehensible, a storage area for storing the certificate set S, a storage area for storing the communication information U, and a storage area for storing the version information V are not required to be arranged adjacent or close to each other. In addition, with respect to the certificate set, it is not mandatory to always handle the public key certificate, the private key, and the root key certificate as a set.

Moreover, a first pubic key certificate of the management subject device 40, which is defined to the management subject device 40 when the management subject device 40 is produced at the production plant E as described above, will be called an “original certificate” in the following.

Since the setting described above is conducted inside the production plant which the manufacturer of the management subject device 40 can manage, it is difficult to leak communication contents to the outside, and it is possible to securely set the certificate. Moreover, even if the management apparatus 30 is arranged outside the production plant E, it is possible to obtain a higher security by conducting a communication between the management apparatus 30 and the communication terminal 150 through a dedicated line.

As described above, in general, in the original certificate and also in the public key certificate, the validated date is set. In a case of requesting the authentication using the pubic key certificate of which the validated date is expired, the authentication is failed. Accordingly, the public key certificate to set in the management subject device 40 is required to be update before the validated date is expired. At this stage, it can be assumed that there are many cases in that the management subject device 40 is used in an environment at a user side such as a business office, a residence, or a like. Thus, it is not easy to set the public key certificate to update in accordance with the same procedure described with reference to FIG. 10 and FIG. 11.

In the following, processes, which are conducted by the management apparatus 30 and the management subject device 40 when updating the public key certificate in a state in that the management subject device 40 is used in the environment at the user side, will be described.

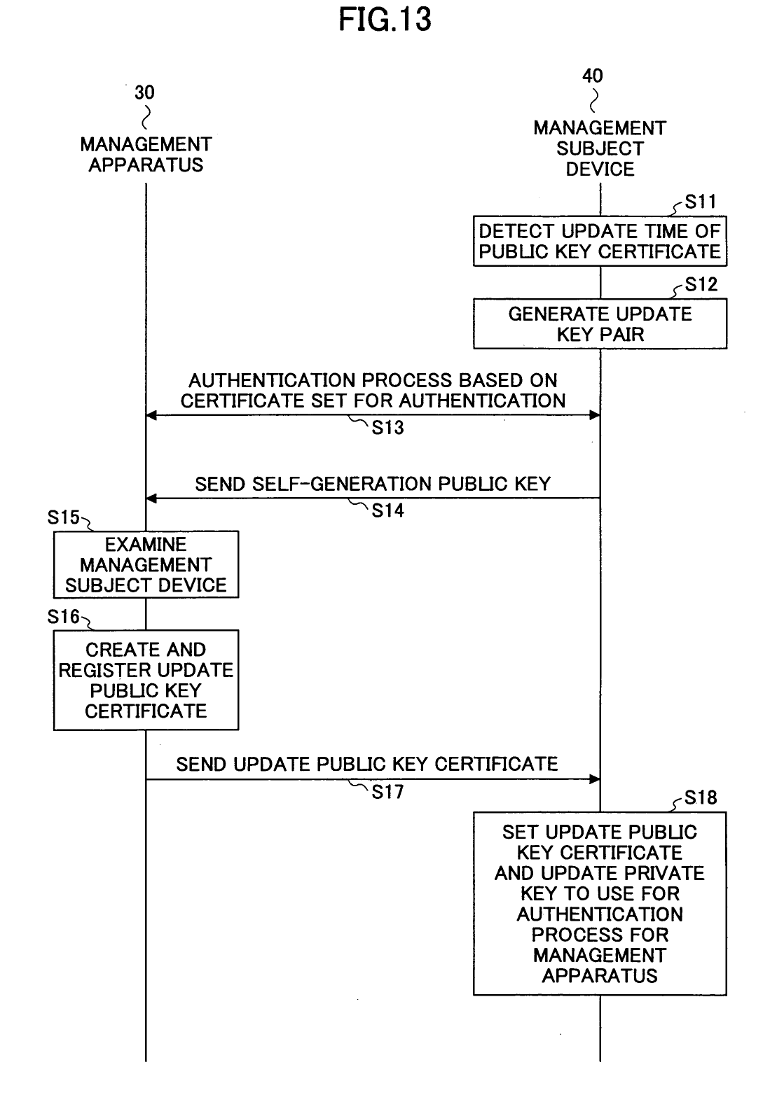

First, in a sequence diagram in FIG. 13, a sequence flow of the entire update process is shown.

As shown in FIG. 13, in an update process, when the management subject device 40 detects that the validated date of the public key certificate to use for the authentication process with the management apparatus 30 is within a certain period (for example, one month ahead of its expiration) (S11), the management subject device 40 determines that the public key certificate reaches at an update time, and conducts a process concerning a certificate update. It should be noted that a condition to start the process concerning a public key update may be defined in another basis.

Then, in steps following to step S11, by the function of the key generation part 48, a pair of a new public key and a new private key are generated as an update key pair (S12). After that, the management subject device 40 regularly conducts the authentication process using the certificate set to use for the authentication process by requesting a communication to the management apparatus 30 (S13). When an authentication is successful, by the function of the key notice part 49, the management subject device 40 sends a notice of a self-generation public key, in which the new public key generated in the step S12 are described as an update public key, to the management apparatus 30 (S14). The notice of the self-generation public key can be considered as a command for requesting the management apparatus 30 to issue the public key certificate in which the digital signature is attached to the public key being sent. Moreover, in the authentication in step S13, the mutual authentication is preferable. However, at least if the management apparatus 30 can authenticate the management subject device 40, any one of the mutual authentication and the one-way authentication can be applied.

When the management apparatus 30 receives the notice of the self-generation public key from the management subject device 40, the management apparatus 30 determines whether or not the public key certificate can be issued in response to the request. Accordingly, by the function of the certificate examination part 36, the management subject device 40 being a sender of the notice is examined (S15). This examination conducts for items described in the public key certificate received from the management subject device 40 when the authentication process is conducted in the step S13, as well as for information of the self-generation public key itself. Details of this examination will be described later.

Then, when the management subject device 40 passes this examination, by the function of the certificate issuance part 37, the management apparatus 30 additionally provides the digital signature to the update public key received form the management subject device 40, creates and issues an update public key certificate, and then registers the update public key certificate to the database of the certificate storage part 34 (S16). Subsequently, the management apparatus 30 sends the update public key certificate created in the step S16 to the management subject device 40 (S17). This transmission can be considered as a response with respect to the command received in the step S14. Moreover, the validated date of the update public key certificate generally at least shows a date later than a validated date of the certificate currently set in the management subject device 40.

Then, when the management subject device 40 receives the update public key, the management subject device 40 sets the update public key certificate received from the management apparatus 30 and the update private key generated in the step S12 as the public key certificate and the private key to use for the authentication process with the management apparatus 30 (S18).

According to the above-described processes, the management subject device 40 can obtain a public key certificate having a longer period until the validate date than the public key certificate being currently used, and can conduct the authentication process with the management apparatus 30 using the public key certificate having the longer period. By conducting these processes, in a case in that the management subject device 40 is in a state possible to communicate with the management apparatus 30, the public key certificate can be updated. These processes can be similarly conducted even in both a case in that the certificate set in the management subject device 40 is the original certificate, and a case in that the certificate has been already updated (the certificate is updated more than once).

In the following, processes conducted by the management apparatus 30 and the management subject device 40 when an update process is conducted will be described in detail.

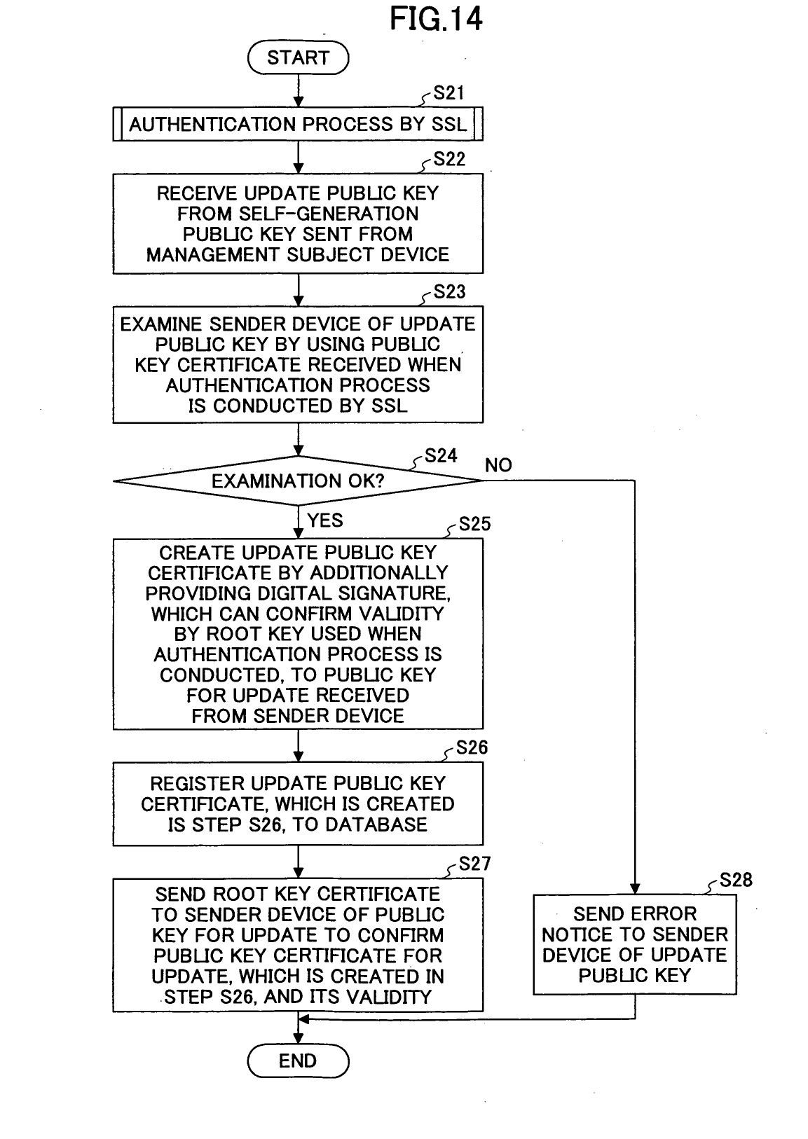

First, FIG. 14 shows a flowchart for explaining a process at the management apparatus 30 in a case of conducting the process shown in FIG. 13. The process shown in FIG. 14 is conducted by the CPU 11 of the management apparatus 30 executing the predetermined control program.

Then, when the management apparatus 30 receives a request of a communication from the management subject device 40, the CPU 11 of the management apparatus 30 starts the process in accordance with the flowchart shown in FIG. 14. First, in step S21, the management apparatus 30 authenticates the management subject device 40 by conducting the authentication process using the SSL. As this process, for example, the process explained with reference to FIG. 1 in the BACKGROUND OF THE INVENTION can be applied, and a detailed explanation thereof will be omitted. However, the public key certificate received from the management subject device 40 in this authentication process is used in a later process. Thus, the public key certificate is stored in a proper storage means.

Moreover, in a case of using a special hardware such as an SSL accelerator to conduct the authentication process using the SSL, it may be difficult for another process to refer to contents of the certificate used for the authentication. In this case, after the authentication succeeded, it is preferable for the management subject device 40 to send the public key certificate with respect to the management apparatus 30 again.

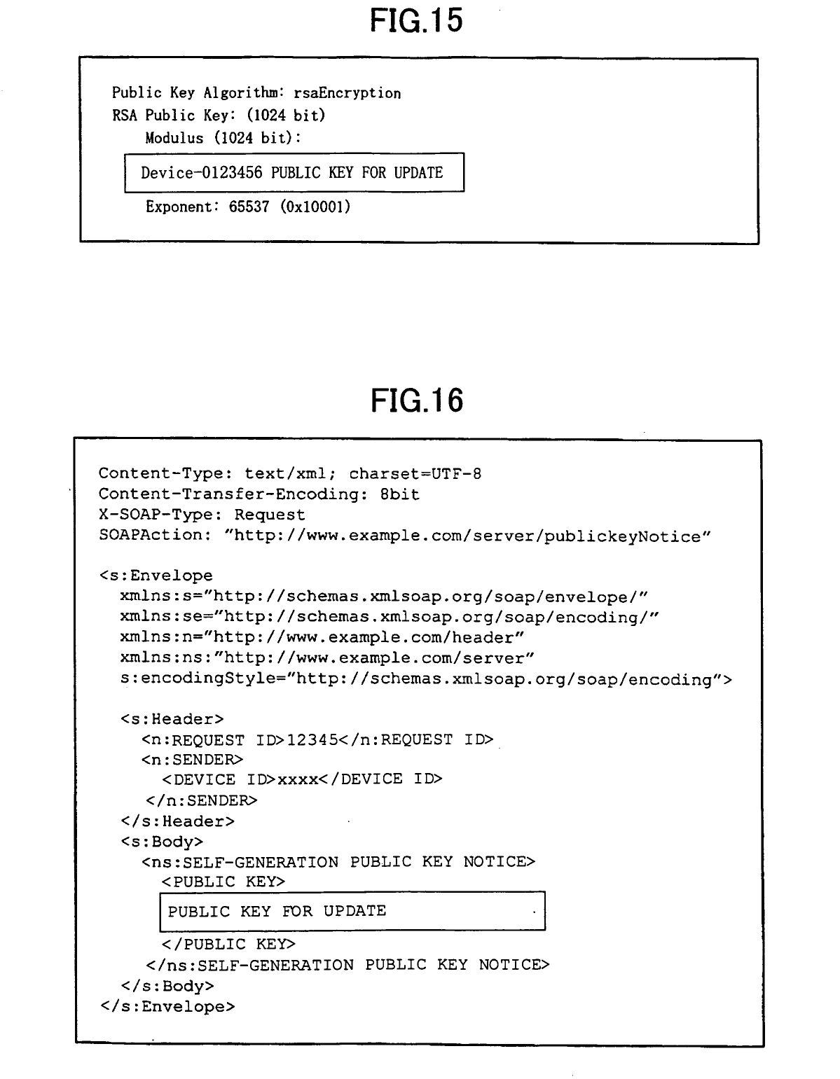

When the authentication is successful in the step S21, in step S22, the management apparatus 30 receives the update public key from the management subject device 40 by the notice of the self-generation public key shown in FIG. 13. For example, a format of the public key received from the management subject device 40 can be a format as shown in FIG. 15. That is, in the body of the public key, information showing a key length of the public key and a generation algorithm are additionally included. However, since it is not required to include information of the management subject device 40 itself, a description example does not includes the information of the management subject device 40 itself.

Moreover, the management subject device 40 can conduct the notice of the self-generation public key in a format of a SOAP (Simple Object Access Protocol) request. In the SOAP request, a message is written in an XML format being a structural language, and a detailed example is shown in FIG. 16. In the detailed example, in a SOAP body, a “self-generation public key notice” tag is written to show the message is for the notice of the self-generation public key, and the update public key is written by a lower tag under the “self-generation public key notice” tag.

A process in this step S22 is a process for a receiving procedure, and in this process, the CPU 11 functions as a receiving means. After the step S22, the management apparatus 30 advances to step S23.

In step S23, by using the public key certificate received when the authentication process using the SSL is conducted in the step S21, the management apparatus 30 examines a sender (the management subject device 40 in this case) of the update public key. If the authentication is successful in the step S21, the sender of the update public key is proper as the communication partner at this point. However, it is preferable to determine whether or not the sender is a proper communication partner to issue the update public key, by applying a different basis from a basis for determining whether or not the sender is the proper communication partner. Thus, another examination procedure is provided.

A process in the step S23 is a process of the examination procedure, and the CPU 11 functions as an examination means in this process.

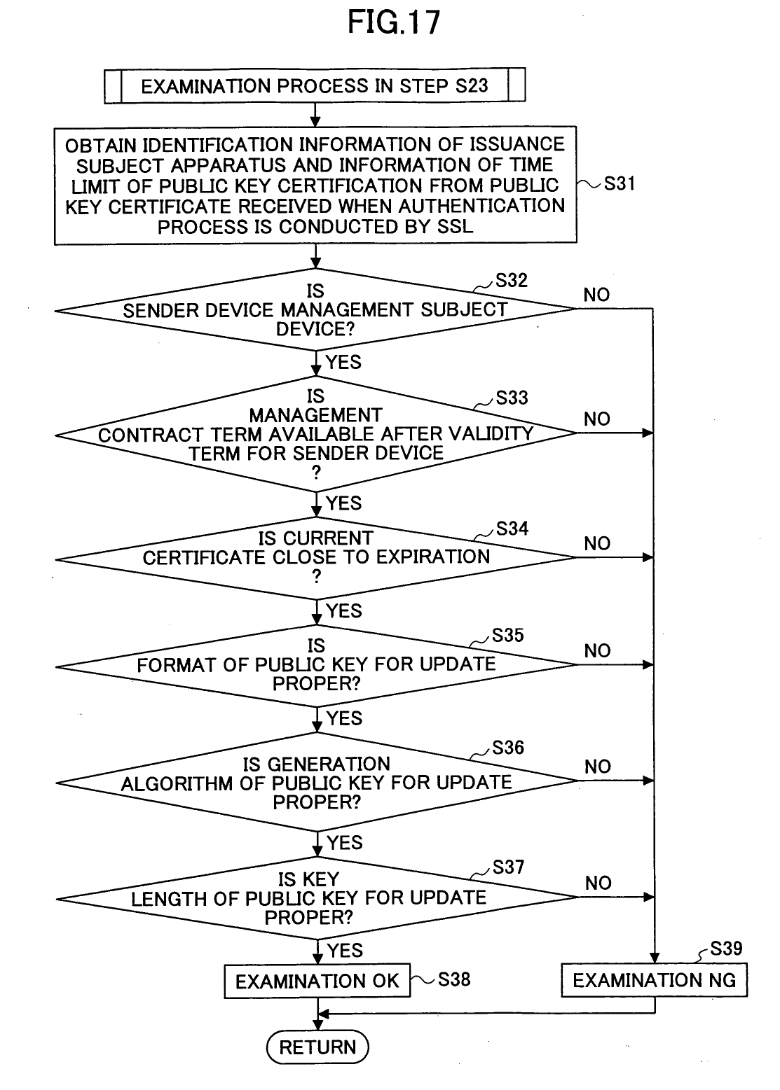

FIG. 17 shows a content example of the examination process in the step S23.

In the examination process shown in FIG. 17, first, in step S31, the identification information of an issuance subject device and information of the public key certificate are obtained from the public key certificate received when the authentication process is conducted by using the SSL.

Subsequently, by using the identification information and the information as keys, a table (not shown) recording information concerning a device as a management subject is referred to, it is determined whether or not a sender device of the update public key is the device as the management subject, and it is determined whether or not a management contract term for the sender device of the update public key is available after the validated date of the public key certificate in use (S32 and S33). With respect to devices other than the device as the management subject of the update public key, it is not necessary to maintain a communication to be available in the future. In addition, if the management contract term is expired before the validated date of the public key certificate in use, it is not necessary to maintain the communication to be available after the management contract term is expired. Thus, if determination results in the steps S32 and S33 show negative results (“NO”), an examination NG (failed) is set in step S39, and then the following process is conducted.

It should be noted that in the step S33, if the validated date of the public key certificate is defined based on the management contract term, it may be determined whether or not the management contract is extended, and then it may be determined based on this result whether or not the management contract term is available.

Moreover, if “YES” in the steps S32 and S33, the examination process advances to step S34, and determines whether or not a current public key certificate is nearly expired (for example, the validated date is within one month). the public key update process shown in FIG. 13 is to be conducted when the public key certificate is nearly expired. When this determination result shows “NO”, it is concerned that some abnormal event occurs. Accordingly, an examination result is set to be an examination NG, and the examination process returns to a main process.

When “YES” in the step S34, in steps S35 through S37, contents of the update public key are checked. In detail, for example, a format is checked (S35), a generation algorithm is checked (S36), and a key length is checked (S37). These checks are conducted based on information described in the update public key. Moreover, for example, if information concerning the update public key is identical to information concerning the public key included in the public key certificate in use, it can be determined that the information concerning the update public key shows proper information.

Then, if any one of the above-described checks shows improper, it can be concerned that some abnormal event occurs. Accordingly, the examination process sets the examination NG in the step S39, and returns the main process.

Moreover, if all the above-described checks in the steps S32 through S37 show “YES”, the examination process sets an examination OK (successful), and returns the main process.

By the above-described process, it is possible to examine the update public key of the sender device, test the contents of the update public key, and determine whether or not the public key certificate is issued. It should be noted that it is not mandatory for this determination process to use the information described in the public key certificate received when the authentication process is conducted by using SSL. However, if the validity of the pubic key certificate is confirmed by using a root key for authenticating the management subject device, which is possessed by itself, it can be considered that the information described in the public key certificate can be trustable and is not tampered. Accordingly, it is preferable to use the information described in the public key certificate.

Moreover, FIG. 17 simple exemplifies items to determined in the examination process. The items may be approximately defined in response to a use aspect of the management subject device 40, a management aspect by the management apparatus 30, or a like.

Returning the explanation with reference to FIG. 14, after the examination process in the step S23, the authentication process advances to step S24, and determines whether or not the examination result shows “OK”. If the examination result shows “OK”, the authentication process advances to step S25, and creates the update public key by additionally providing the digital signature possible to check the validity by the root key used when the authentication process is conducted, to the update public key received in the step S22.

In providing the digital signature, the identification information of an issuance destination device of the public key certificate or a device with which the digital signature is attached, bibliography information such as a serial number of the certificate, a validated date, and a like are included, and further a hash value obtained by conducting the hash process to the entire identification information and bibliography information is encrypted by using the root private key and is included. Accordingly, the update public key certificate is the public key certificate including the update public key. Then, the root private key used in this process corresponds to the root key included in the root key certificate for authenticating the management subject device used when the authentication process is conducted between the management apparatus 30 and the management subject device 40. Also, the root private key is the same as the root private key used when the digital signature is additionally provided to the public key certificate of the management subject device 40, which is received when the authentication process is conducted in the step S21.

Moreover, similar to a case of the original certificate, the bibliography information to provide to the update public key is issued with respect to the management subject device 40 by the management apparatus 30. At least, the identification information of the issuance destination device of the public key certificate or the device with which the digital signature is attached is the same as the identification information of the public key certificate of the management subject device 40 received when the authentication process is conducted. In this case, information other than the serial number and the validated date is the same as information of the public key certificate of the management subject device 40 received when the authentication process is conducted.

A process conducted in the step S25 is a process of a certificate creation procedure, and the CPU 11 functions as a certificate creation means in this process.

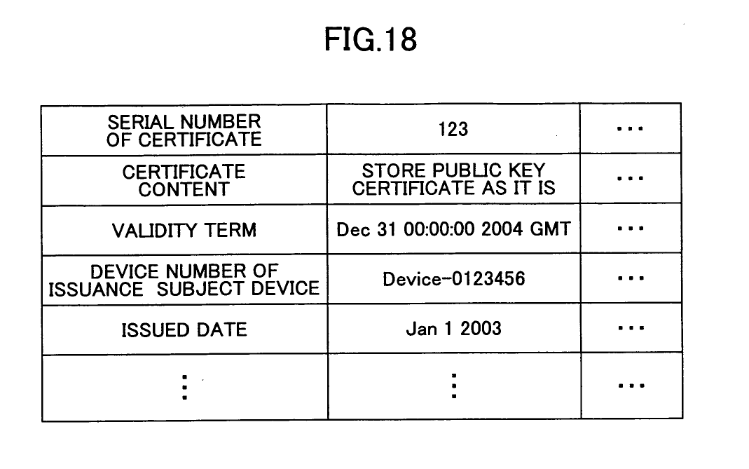

Next, in step S26, the update public key certificate issued in the step S25 is registered in the database of the certificate storage part 34. A database example is shown in FIG. 18. In FIG. 18, items to register to the database are, for example, a serial number of a certificate, a certificate content, a validated date, a device number of an issuance subject device, an issued date of the certificate, and a like. For the certificate content, the public key certificate is stored as it is issued. Items other than the certificate content may be stored by extracting from items of the bibliography information provided to the public key certificate.

It is not mandatory to create the above-described database. However, by storing an issued public key certificate, in a case in that an abnormal event occurs to a management operation, an authentication operation, or a like, it is possible to obtain the public key certificate by searching by using a proper item as a key, and use to find out a cause of the abnormal event.

The authentication process advances to step S27 after the step S26, and sends the update public key certificate issued in the step S25, the root key certificate for authenticating the management subject device to confirm its validity, and the update public key to the sender device. After that, the authentication process at the management apparatus 30 is terminated.

As shown in FIG. 7A and FIG. 7B, the management subject device 40 does not store the root key certificate for confirming the validity of the public key certificate, which is stored in the management subject device 40 itself. Accordingly, in the step S27, with the update public key certificate, the root key certificate (the root key certificate for authenticating the management subject device) including a root key for confirming its validity may be sent to the sender device. By conducting this manner, the management subject device 40 can confirm that the update public key certificate received from the management apparatus 30 is not compromised, by using the root key certificate, and then set the update public key certificate in the management subject device 40. Therefore, it is possible to increase the security of an update process for updating the public key certificate.

If the management subject device 40 sets the update public key certificate being compromised, the authentication process with the management apparatus 30 is failed, and the management subject device 40 cannot communicate with the management apparatus 30. As a result, it takes time to solve a problem and recover the management subject device 40. In order to predict this state, it is preferable to send the root key certificate for authenticating the management subject with the update public key certificate to the management subject device 40. However, it is not mandatory to send the root key certificate.

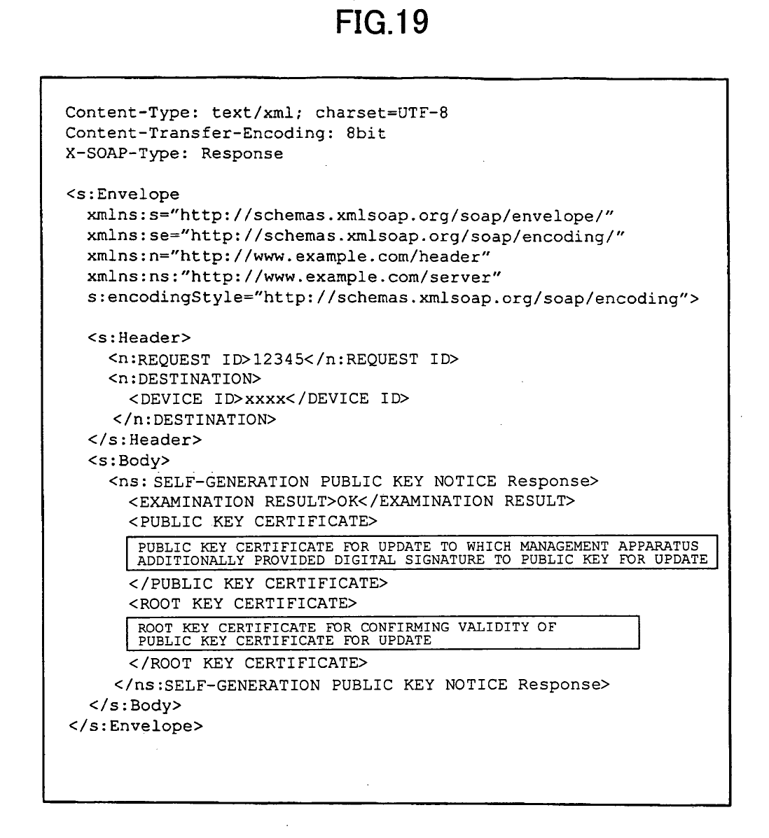

Moreover, the update public key certificate and the root key certificate can be sent in a form of a SOAP response with respect to a SOAP request for the notice of the self-generation public key. A message in the SOAP response is written in a form of the XML as shown in FIG. 19 in detail. In this example, in a SOAP body, a “SELF-GENERATION PUBLIC KEY NOTICE response” tag showing a response with respect to the notice of the self-generation public key is provided. At a lower tag under this tag, the examination result (OK) in the step S23, the update public key certificate, and the root key certificate for confirming its validity are described.

Moreover, if the examination result in the step S24 shows “NG”, the authentication process advances to step S28, instead of the update public key certificate, an error notice describing a failure reason at the examination is sent to the sender device of the update public key, and the authentication process is terminated.

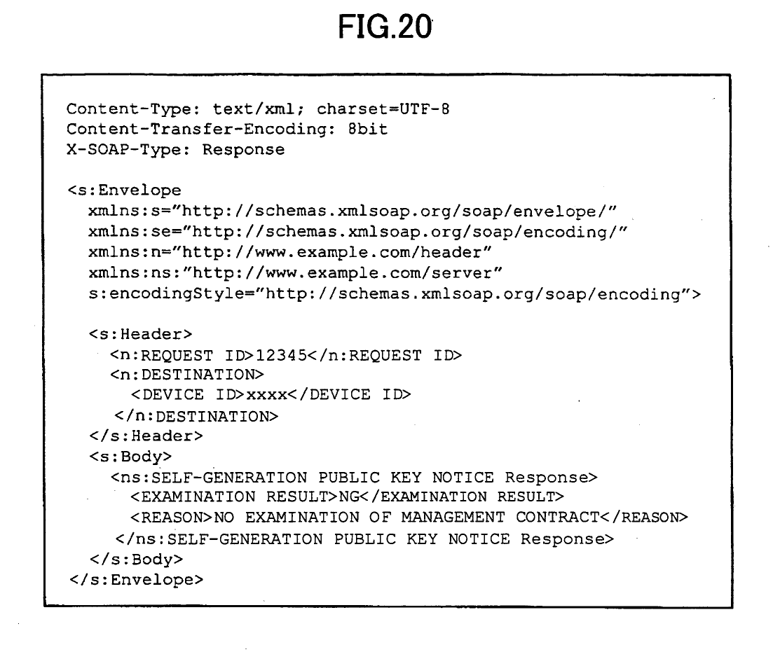

The error notice can be conducted in the form of the SOAP response with respect to the SOAP request of the notice of the self-generation public key. In this case, the details are shown in FIG. 20. In this example, in the SOAP body, a “SELF-GENERATION PUBLIC KEY NOTICE response” tag showing a response with respect to the notice of the self-generation public key is provided. At a lower tag under this tag, the examination result (NG) in the step S23 and the failure reason are described.

If the failure reason at the examination shows special contents, for example, if there is still a time until the validated date of the public key certificate in use, this state may be informed to an operator of the management apparatus 30, and the operator may contact with a user of the management subject device 40.

As described above, when the management apparatus 30 receives the public key from the management subject device 40, and determines that the public key certificate can be sent to the management subject device 40 based on the examination result, the management apparatus 30 can send the public key certificate including the received public key.

In a case of considering the notice of the self-generation public key as the same as other commands, the management apparatus 30 is not required to recognize that the update process for the public key certificate is conducted at the authentication process using the SSL before the notice of the self-generation public key is received. When the management apparatus 30 receives the notice of the self-generation public key (command) from the management subject device 40, processes after the step S23 may be conducted as processes in response to this command. However, in this case, if information included in the public key certificate received from the management subject device 40 is used for the examination when the authentication process using the SSL is conducted, the public key certificate is stored at the authentication process.

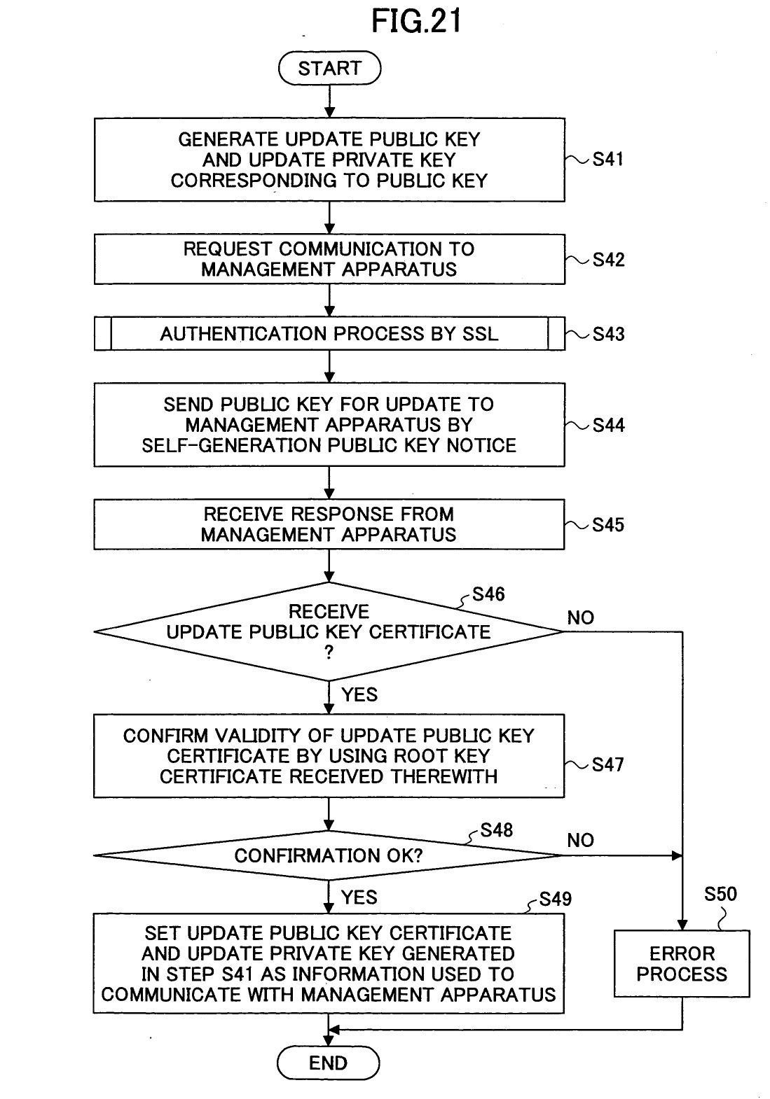

Next, FIG. 21 shows a flowchart of a process at the management subject device 40 in a case of executing the process shown in FIG. 13. The process shown in FIG. 21 is conducted by the CPU if the management subject device 40 executing the predetermined control program.

Then, when the CPU of the management subject device 40 detects that the validated date of the public key certificate in use is close to expiration in the authentication process with the management apparatus 30, the CPU of the management subject device 40 begins the process in accordance with the flowchart in FIG. 21.

First, in step S41, an update pubic key and an update private key are generated as a key pair for update. When the key pair is generated, as shown in FIG. 15, in addition to the key body, necessary bibliography information is additionally included.

After that, the management subject device 40 requests communication to the management apparatus 30 in step S42, and conducts the authentication process using the SSL with the management apparatus in step S43. At this stage, at least, the management subject device 40 is authenticated by the management apparatus 30. However, the management subject device 40 may also authenticate the management apparatus 30. In this case, for example, the authentication process described with reference to FIG. 1 in the BACKGROUND OF THE INVENTION can be applied.

Then, when the authentication process in the step S43 is successfully conducted, the notice of the self-generation public key described in the update public key is generated in step S44. The update public key is sent to the management apparatus 30 by this notice of the self-generation public key. After that, the management subject device 40 waits for a response from the management apparatus 30, and receives the response in step S45.

As described with reference to FIG. 14, the response from the management apparatus 30 describes the update public key certificate, which the management apparatus 30 issued by additionally providing the digital signature to the update public key, and the root key certificate for confirming its validity, or the error notice. Thus, in step S46, the management subject device 40 determines whether or not the update public key certificate is received.

If the management subject device 40 receives the update public key certificate, the management subject device 40 advances to step S47, and confirms the validity of the update public key certificate by using the received root key certificate. When the validity is confirmed, the management subject device 40 advances to step S49 from the step S48, and sets the update public key certificate received from the management apparatus 30, and the update private key generated in the step S41 as the key pair to use for the communication with the management apparatus 30, and then terminate this process.

On the other hand, if the management subject device 40 has not received the update public key in the step S46 (that is, the management subject device 40 receives the error notice), or if the management subject device 40 cannot confirm the validity of the update public key certificate in the step S48, the management subject device 40 conducts an error process in step S50, and then terminates this process.

Contents of the error process are different based on contents of the error notice or a confirmation result of the update public key certificate. For example, if the management subject device 40 cannot confirm the validity of the update public key, it is determined that the update public key is compromised, the process is conducted in accordance with the flowchart in FIG. 21, again. If the management contract term has not been extended, a guide message of a contract extension may be displayed at a display unit.

Moreover, the examples shown in FIG. 19 and FIG. 20, in a case of describing the examination result to the response, it may be determined whether or not the examination result shows “OK” or “NG” in the step S47. In this case, “OK” corresponds to “YES” and “NG” corresponds to “NO”.

By the describe above process, when the update is successful, it is possible to set the public key certificate, which the management apparatus 30 created by additionally providing the digital signature to the public key generated by the management subject device 40 itself, as the public key certificate to use for the authentication with the management apparatus 30. In addition, regarding to the private key, it is possible to set the private key corresponding to the public key generated by the management subject device 40 itself, to use for the authentication with the management apparatus 30.

In this case, contents of the certificate memory before the update as shown in FIG. 12 are replaced with portions of the public key certificate and the private key after the update.

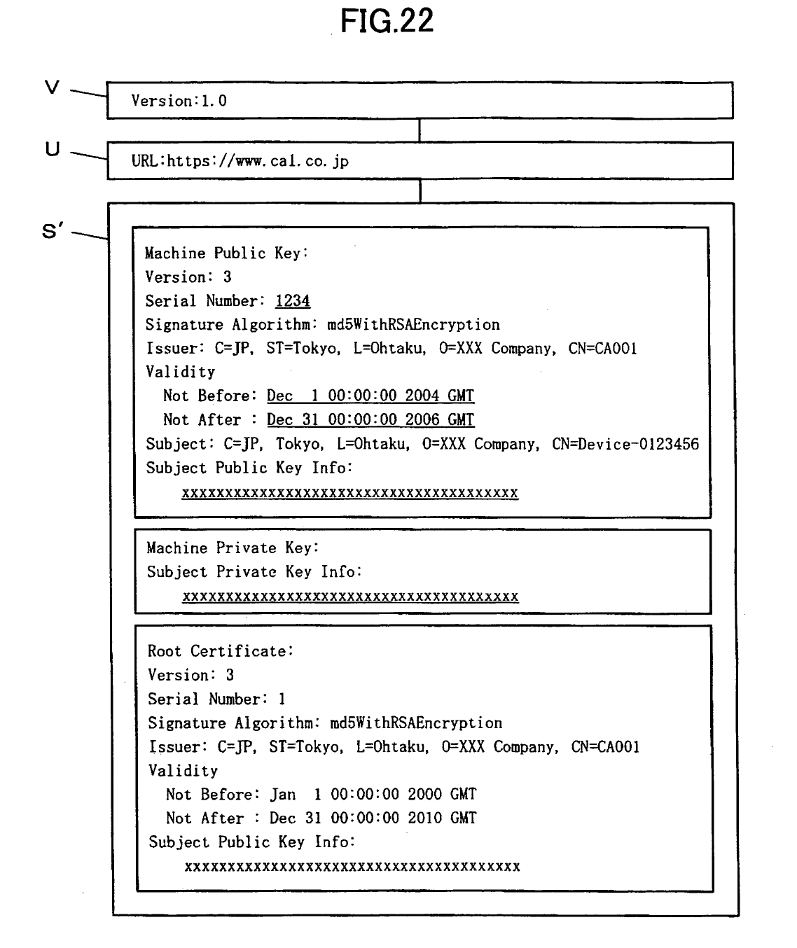

FIG. 22 shows the contents of the certificate memory after update. In FIG. 22, portions, which are changed before and after update, are shown with underlines.

As seen from FIG. 22, the public key (including the digital signature) and the private key are eventually changed before and after update. Regarding other portions, mainly, only the serial number and the validated date of the public key certificate are changed. A signature algorithm, a signer, the identification of the issuance destination of the public key certificate, and a like are not changed since before update.

Accordingly, it can be recognized that in the public key certificate after update, the validated date is simply updated with a validated date having a longer term.

In the update process of the public key certificate as above-described, the private key used by the management subject device 40 is generated by the management subject device 40 itself, and is not sent to other devices after that. Thus, there is no risk of spying on the private key during the transmission. Therefore, the possibility of leaking the private key during the update process becomes lower, and higher security can be maintained. In addition, since the private key stored in another device cannot be illegally used even after update, higher security can be maintained.

Moreover, according to the method as above-described, since it is possible to automatically update the public key certificate, in this method, if a certificate transmission apparatus for transmitting the public key certificate, a communication system including the certificate transmission apparatus, and a like are applied to a device impossible to update the certificate by operator at an arrangement place, for example, an image forming apparatus that is to be a subject of a remote maintenance, such as a set-top box of a cable television, or a like.

Moreover, regarding another method other than the method described above, it can be considered that when the public key certificate is updated, for example, the management apparatus 30 creates a key pair of the public key and the private key for update in response to a request, the public key certificate and the private key are transmitted to the management subject device 40 to set thereto. However, in the method described above, it is possible to update the public key certificate in a state in that devices other than a device to store the private key cannot control at all. Therefore, since the private key is not transmitted through a network, it is possible to obtain higher security than a method in that the management apparatus 30 generate the key pair.

The private key should be possessed only by a device using this private key. However, if the CA and the management apparatus 30 distribute the private key, not only the device using the private key but also the CA and the management apparatus 30 posses the private key. If the same subject manages the CA, the management apparatus 30, and the private key, no problem is raised. However, in a case in that a vender provides a management service by the management apparatus 30 to a user of a device or a like, the use may not prefer a state in that the management apparatus may have the private key of the device. Preferably, only the device can have the private key.

In the above-describe method according to the present invention, advantageously, it is possible to issue the public key certificate with respect to the management subject device while the private key used for the authentication by the management subject device 40 can not be possessed by the management apparatus 30 and other devices.

Even in a case of applying the above-described method, a certificate set to originally store in the management subject device at the production plant is always generated at the management apparatus 30, and is transmitted to the communication terminal in the production plant. However, since the management subject device 40 uses the private key generated by the management subject device 40 itself from a shipping stage, even in the production plant, the certificate may be set by one of processes described with reference to FIG. 13 through FIG. 21. By this manner, from an original shipping stage, the management subject device 40 can use the private key having higher security.

In this case, a method, in which the management apparatus 30 examines the management subject device 40 in a state in that the public key certificate is not set to the management subject device 40, raises a problem. For this problem, for example, such as the process shown in FIG. 11, the operator reads a barcode by using a barcode reader, and sends contents of the barcode to the management apparatus 30 through the communication terminal 150, and then the examination can be conducted. Alternatively, the certificate set which is set by the process described with reference to FIG. 11 is defined as a tentative certificate set. After that, the management subject device 40 can update the certificate by any one of the processes described with reference to FIG. 13 through FIG. 21 by itself.

Moreover, at a place other than the production plant, the tentative certificate set is defined to use. After that, the management subject device 40 updates the certificate by any one of processes described with reference to FIG. 13 through FIG. 21 by itself, so that an official certificate set is defined to use for the authentication process. By applying this method, it is effective for a recovery operation or a like in a case in that the certificate set being used is lost due to a damage of a memory or a like.

Moreover, in the embodiment described above, a case example, in which the management apparatus 30 is provided with a function of the CA, and the management apparatus 30 provides the digital signature by itself, has been described. However, the management apparatus 30 and the CA can be separately arranged. In this case, for example, after the management apparatus 30 examines a management device being a subject and a sender device of the update public key and determines that the management device passes this examination, the management apparatus 30 sends the update public key to the CA and requests the CA to issue the update public key certificate by additionally providing the digital signature. Then, the management apparatus 30 can receive the update public key certificate issued by the CA, and can send the update public key to the management subject device 40. In this case, preferably, a communication path between the CA and the management apparatus 30 is a dedicated line. However, if a secured communication path is maintained by the SSL, a VPN, or a like, the communication path can be established through the Internet.

Furthermore, in the embodiment described above, the communication system in that the management apparatus 30 manages the management subject device 40 has been described. However, it is not mandatory for a device having a function sending the public key certificate to manage a device as a transmission subject. If a simple mutual data communication can be applied, the present invention can be applied to this case.

Moreover, in the embodiment described above, the management apparatus 30 and the management subject device 40 conduct the authentication in accordance with the SSL describe with reference to FIG. 1 or FIG. 3. Alternately, another authentication can be used and also the present invention brings out effects.

A TSL (Transport Layer Security), which improves the SSL, is well-known. In a base of conducting the authentication process based on this protocol, the present invention can be applied. In addition, regarding a method of the public key encryption, not only an RSA (Rivest Shamir Adleman) but also an Elliptic Curve Cryptography or a like can be applied.

Moreover, each variation of the above-described methods can be applied by an appropriate combination.

Furthermore, the program according to the present invention is a program to realize the above-described functions in a computer controlling the management apparatus 30. By causing the computer to execute the program, the above-described effects can be obtained.

The program may be stored in a storage unit such as a ROM or an HDD originally mounted in the computer. Also, the program can be providing by recording to any other recording media such as a CD-ROM, a flexible disk, and non-volatile memories such as an SRAM ((Static RAM), an EEPROM (Electronically Erasable and Programmable Read Only Memory), a memory card, and a like. The program recorded in a memory is installed into the computer to cause CPU to execute the program, or the CPU reads out the program from the memory to execute each of processes described above.

Furthermore, the program may be downloaded from an external device with a recording medium recording the program and connected to a network or an external device recording the program in a storage unit to execute the program.

As described above, by the certificate transmission apparatus, the communication system, the certificate transmission method, the computer-executable program product, or the computer-readable recording medium according to the present invention, it is possible to automatically update the public key certificate used for the authentication at the communication device. Also, it is possible to reduce a possibility of leaking the private key and to realize a secured update.

Accordingly, by applying the present invention in a case of operating the communication system that conducts the authentication process using a digital certificate for each of nodes to communicate with each other, even if the public key certificate having the validated date is used for the authentication process, it is possible to reduce spoofing, and to realize more secured system.

According to the certificate transmission apparatus, the communication system, or the certificate transmission method according to the present invention, it is possible to reduce a possibility of leaking the private key and to realize a secured update, while the public key certificate used for the authentication at the communication device can be automatically updated.

Moreover, the computer-executable program product according to the present invention causes a computer to function as the above-described certificate transmission apparatus and to realize the above-described features and similar effects. Also, the computer-readable recording medium according to the present invention causes a computer, which does not include program code according to the present invention, to read out and execute the program code, and to realize the similar effects.

The present invention is not limited to the specifically disclosed embodiments, and variations and modifications may be made without departing from the scope of the present invention.

The present application is based on the Japanese Priority Applications No. 2004-211626 filed on Jul. 20, 2004 and No. 2005-187219 filed on Jun. 27, 2005, the entire contents of which are hereby incorporated by reference.

What is claimed is:

1. A certificate transmission apparatus, comprising:
a receiving part receiving a public key created by a sender device;
an examination part examining the sender device of the public key; and
a sending part sending a public key certificate including the public key received by the receiving part to the sender device of the public key.

2. The certificate transmission apparatus as claimed in claim 1, further comprising a certificate creation part creating the public key certificate by additionally providing a digital signature to the public key received by the receiving part.

3. The certificate transmission apparatus as claimed in claim 2, wherein the certificate creation part comprises a part describing identification information of the sender device of a received public key certificate to the public key certificate which is to create, the identification information being described in the received public key certificate.

4. The certificate transmission apparatus as claimed in claim 1, wherein the examination part examines the sender device by using a received public key certificate in order to establish a communication path when the public key is received from the sender device of the public key.

5. The certificate transmission apparatus as claimed in claim 4, wherein the public key certificate used for an examination conducted by the examination part is a public key certificate set to the sender device when the sender device is manufactured.

6. The certificate transmission apparatus as claimed in claim 4, wherein the examination part comprises a part conducting the examination of the sender device by using identification information of the sender device of a received public key certificate, the identification information is described in the received public key certificate.

7. The certificate transmission apparatus as claimed in claim 1, wherein the sending part comprises a part sending the publication key certificate and a certificate key for confirming a validity of the public key certificate when the public key certificate is sent.

8. A communication system, comprising:
a certificate transmission apparatus; and
a communication device,
wherein:
the certificate transmission apparatus comprises:
a receiving part receiving a public key;
an examination part examining a sender device of the public key; and
a sending part sending a public key certificate including the public key received by the receiving part to the sender device of the public key, when the sender device passes an examination conducted by the examination part, and
the communication device comprises:
a first part generating the public key and a private key, which are to be a pair;
a second part sending the public key generated by the first part; and
a third part receiving the public key certificate from the certificate transmission apparatus.

9. The communication system as claimed in claim 8, wherein the certificate transmission apparatus comprises a certificate creation part creating the public key certificate by additionally providing a digital signature to the public key received by the receiving part.

10. The communication system as claimed in claim 9, wherein the certificate creation part of the certificate transmission apparatus comprises a part describing identification information of the sender device of a received public key certificate in another public key certificate, which is to create, the identification information being described in the received public key certificate.

11. The communication system as claimed in claim 8, wherein:
the examination part of the certificate transmission apparatus examines the sender device by using a received public key certificate in order to establish a communication path when the public key is received from the sender device of the public key, and
the communication device comprises a fourth part sending the public key certificate, which is possessed by the communication device, to the certificate transmission apparatus in order to establish the communication path when the public key is sent to the certification transmission apparatus.

12. The communication system as claimed in claim 11, wherein the public key certificate, which the communication device sends to the certificate transmission apparatus in order to establish the communication path, is a public key certificate set to the communication device when the communication device is manufactured.

13. The communication system as claimed in claim 11, wherein the examination part of the certificate transmission apparatus comprises a part conducting an examination of the sender device by using identification information of the sender device of a received public key certificate, the identification information described in the received public key certificate.

14. The communication system as claimed in claim 8, wherein the sending part of the certificate transmission apparatus comprises a part sending the public key certificate and a certificate key for confirming a validity of the public key certificate when the public key certificate is sent.

15. A certificate transmission method, comprising the steps of:
receiving a public key created by a sender device;
examining the sender device of the public key; and
sending a public key certificate including the public key received in receiving the public key, to the sender device, when the sender device passes an examination conducted in examining the sender device.

16. The certificate transmission method as claimed in claim 15, further comprising the step of creating the public key certificate by additionally providing a digital signature to the public key received in receiving the public key.

17. The certificate transmission method as claimed in claim 16, wherein the creating the public key certificate comprises the step of describing identification information of the sender device of a received public key certificate to the public key certificate to be created in creating the public key certificate, the identification information described in the received public key certificate.

18. The certificate transmission method as claimed in claim 15, wherein in examining the sender device, an examination of the sender device is examined by using the public key certificate being receive, to establish a communication path when the public key is received from the sender device of the public key.

19. The certificate transmission method as claimed in claim 18, wherein the public key certificate used in the examination in examining the sender device is a public key certificate set to the sender device of the public key when the sender device is manufactured.

20. The certificate transmission method as claimed in claim 18, wherein the examining the sender device comprises the step of conducting the examination of the sender device by using identification information of the sender device of a received public key certificate, the identification information described in the received public key certificate.

21. The certificate transmission method as claimed in claim 15, wherein the sending the public key certificate comprises the step of sending the public key certificate and a certificate key for confirming a validity of the public key certificate when the public key certificate is sent.

22. A computer-executable program product for causing a computer to send a public key certificate, comprising program code for:
receiving a public key created by a sender device;
examining the sender device of the public key; and
sending a public key certificate including the public key received in receiving the public key, to the sender device, when the sender device passes an examination in the examining the sender device.

23. The computer-executable program product as claimed in claim 22, further comprising program code for creating the public key certificate by additionally providing a digital signature to the public key received in the receiving the public key.

24. The computer-executable program product as claimed in claim 23, wherein the creating the public key certificate comprises program code for describing identification information of the sender device of a received public key certificate to the public key certificate to be created, the identification information described in the received public key certificate.

25. The computer-executable program product as claimed in claim 22, wherein in examining the sender device, the sender device is examined by using the received public key certificate in order to establish a communication path when the public key is received from the sender device of the public key.

26. The computer-executable program product as claimed in claim 25, wherein the public key certificate used to examine the sender device in examining the sender device is a public key certificate set to the sender device when the sender device is manufactured.

27. The computer-executable program product as claimed in claim 25, wherein the examining the sender device comprises the program code for conducting an examination of the sender device by using identification information of the sender device of the received public key certificate, the identification information described in the received public key certificate.

28. The computer-executable program product as claimed in claim 22, wherein the sending the public key certificate comprises the program code for sending the public key certificate and a certificate key for confirming a validity of the public key certificate when the public key certificate is sent.

29. A computer-readable recording medium recorded with a program for causing a computer to send a public key certificate, the program comprising codes for:
receiving a public key created by a sender device;
examining the sender device of the public key; and
sending a public key certificate including the public key received in receiving the public key, to the sender device, when the sender device passes an examination in the examining the sender device.
